(19) United States
(12) Patent Application Publication
(10) Pub. No.: US 2022/0265516 A1
(43) Pub. Date: Aug. 25, 2022

(54) DOSING AND ADMINISTRATION SYSTEM FOR DRUG COMBINATIONS

(71) Applicants: HERMES PHARMA GMBH, Pullach (DE); MÜHLEMANN IP GMBH, Stein am Rhein (CH)

(72) Inventors: Marieke GOSAU, Pullach (DE); Sonja SCHERTEL, Pullach (DE); Rolf MÜHLEMANN, Schlattingen (CH)

(21) Appl. No.: 17/596,593

(22) PCT Filed: Jun. 12, 2020
(86) PCT No.: PCT/EP2020/066362

§ 371 Date: Dec. 14, 2021

(30) Foreign Application Priority Data
Jun. 14, 2019 (EP) 19180390.7

(51) Int. Cl. A61J 1/20; A61J 7/00; B65D 81/32

(52) U.S. Cl. CPC A61J 1/2089; A61J 1/2048; A61J 7/0046; A61J 1/2093; B65D 81/3205; B65D 81/3216

(57) ABSTRACT

The present invention provides a cartridge for the preparation of a liquid pharmaceutical or nutraceutical formulation, the cartridge being adapted for insertion into a mixing vessel and for dispensing at least three flowable pharmaceutical or nutraceutical compositions into said mixing vessel, the cartridge comprising a container portion, a cover portion and an opening means, or more specifically an opening means of the container portion, for opening the cartridge, preferably after its insertion into the mixing vessel, wherein the container portion comprises a container wall and a container base, the container wall and the container base defining an inner lumen and an opening of the container portion, the opening being positioned opposite to the container base, and a segmenting structure located in the inner lumen of the container portion and being physically connected to the container wall and/or to the container base such as to divide the inner lumen of the container portion into at least three segments containing the at least three flowable pharmaceutical or nutraceutical compositions.

### BACKGROUND OF THE INVENTION

The present invention relates to dispensing devices for the administration of pharmaceutical or nutraceutical compositions or formulations. Specifically, the present invention relates to a cartridge for the preparation of a liquid pharmaceutical or nutraceutical formulation, wherein the cartridge can be attached to, or inserted into, a corresponding mixing vessel.

Dispensing devices in the form of capsules, which are to be broken open or punctured to dispense their contents, so that the metered amount of the ingredients can be dispensed, have been known for many years already. For example, plastic capsules, which are sealed with an aluminium foil and can be torn open by a protruding pull tab accordingly, have been known for a very long time. Such capsules are used to dispense coffee creamer, for example, or salad dressing, honey, marmalade or many other foods. However, such dispensing devices are also known for industrial applications, for example in order to add predefined dosing amounts of fertilizers, herbicides or insecticides, which are combined with the second, substantially larger amount of liquid base.

Such dispensing devices serve not only for metered dispensing of liquid or portable substances but also frequently serve to increase the stability of pharmaceutical drugs or beverages, to which an increased amount of vitamins has been added or other active ingredients that are not very stable in aqueous phase but can be stored for a practically unlimited period of time in powder form. In such cases, such dispensing devices are combined directly with the closure and can already be dispensed into the aqueous phase of the container on opening the closure or before opening the closure. Typical examples of such possibilities include bottles for isotonic beverages to which vitamins in high doses and other active ingredients are added.

More and more foodstuffs, medicines, cosmetics, adhesives and cleaning agents, as well as other substances described altogether as active ingredients, are offered in highly concentrated form. This has the advantage of reducing package size lowering of transport costs and thereby reducing using packaging expenditure. The disadvantages are that all these active ingredients in a highly concentrated form must be subsequently dosed to obtain the required usage quantities and then be added in a dosed manner to a liquid, i.e. a solvent in the widest sense. Frequently, consumers do not take sufficient notice of the advice regarding the dose quantity and tends to dispense a much higher concentration than required which is detrimental to the end product to be used or administered.

WO 2009/092628 A1 discloses a capsule for use in a beverage production device, the capsule containing ingredients for producing an nutritional liquid when the liquid is fed into the capsule at the inlet face thereof, the capsule furthermore containing heat sensitive bioactive ingredients such as probiotic microorganisms which are physically separated from the other nutritional ingredients in the capsule.

US 2011/0272302 A1_discloses a compartmentilised container comprising, in separate container segments, all components required for the preparations of common cocktails; for instance, alcoholic components (gin, rum, vodka, tequila, whiskey, etc.), water, sugar, honey, cream, milk, fruit juices, solid fruits or pieces thereof (oranges, limes, grenadine, olives, cherries, etc.). The compartmentilised container is equipped with a coupler (either attached to the container or as an integral part thereof) for receiving e.g. a common drinking glass, said coupler improving connectivity between the container and said glas, and thereby helping to reduce spills when emptying the container contents into the glass. Furthermore, the compartmentilised container is equipped with a membrane closure which seals off all segments of the container to prevent premature mixing or contact of the segmented components. Said membrane thus needs to be fully removed prior to receiving the drinking glass in the coupler in order to empty out all of the contents into the drinking glass. Unfortunately, this approach entails the risk of unintentionally spilling contents after removal of the membrane, e.g. by accidentally tipping over the opened container before the drinking glass is put sealingly in place over the container opening. And while oftentimes such spilled contents may be recoverable from a non-absorbent surface to some extent, such incomplete recovery would be unacceptable for pharmaceutical or nutraceutical compositions, since they have higher demands in terms of dosing accuracy and pharmacologic efficacy than e.g. an alcoholic cocktail.

US 2013/0193010 A1, accordingly, discloses a plastic closure with integrated capsule for dispensing solid, granulated on liquid active ingredients, comprising a cylindrical or conical pressure-resistant capsule wall with a chamber closable at its lower ends by means of a sealing film, wherein, in the area of the upper end of the capsule wall, a convex, flexible membrane is formed onto the same in one piece therewith, by means of which a piercing member can be operated, wherein the plastic closure part comprises a shell wall with fastening means which are connected with the capsule wall via a ring shaped covering surface, and the shell wall concentrically encircles the capsule wall, and in that the piercing member, prior to the operation of the convex membrane, rests completely inside the chamber, which is characterized in that a replaceable piercing member can be brought in to operate if contact with the lower face of the flexible membrane.

US 2016/0362236 A1 discloses a simple, cost-effective dispensing device that can be used independent of a container having a peripheral outer wall which defines a dispensing space. The dispensing space is closed by the tear-resistant film on the push-open side, whereas the cover side is closed by a cover plate which can be formed in one part with the peripheral outer wall. The dispensing space can be subdivided into chambers by connecting walls. However, the dispensing space also holds a guide channel with guide walls that is closed on all sides with respect to the dispensing space. A piston-like ram or plunger is mounted in the guide channel to successively push open the tear resistant film and the active ingredients in the chambers are thus dispensed.

Recently, however, more and more active ingredients, more specifically active pharmaceutical ingredients are administered and consumed in combination, either in combination with other active pharmaceutical ingredients or in combination with other ingredients or excipients useful or necessary in the context of pharmacotherapy. Especially in the context of liquid pharmaceutical compositions for oral intake the prior art does not provide satisfactory technical solution for the preparation and administration of such combination regimens which take advantage of the consumer- or patient friendly features of current dispensing device technology. Accordingly, there is still need for a dispensing device which allows for the easy and reliable preparation of pharmaceutical or nutraceutical composition for oral intake which comprises a plurality of active or other ingredients.

### SUMMARY OF THE INVENTION

In a first aspect, the present invention provides a cartridge for the preparation of a liquid pharmaceutical or nutraceutical formulation, preferably comprising at least two active pharmaceutical ingredients and at least one excipient, the cartridge being adapted for insertion into a mixing vessel and for dispensing at least three flowable pharmaceutical or nutraceutical compositions into said mixing vessel, the cartridge comprising a container portion, a cover portion and an opening means, or more specifically an opening means of the container portion, for opening the cartridge, preferably after its insertion into the mixing vessel, wherein
the container portion comprises
a) a container wall and a container base, the container wall and the container base defining an inner lumen and an opening of the container portion, the opening being positioned opposite to the container base, and
b) a segmenting structure located in the inner lumen of the container portion and being physically connected to the container wall and/or to the container base such as to divide the inner lumen of the container portion into at least three segments containing the at least three flowable pharmaceutical or nutraceutical compositions; and
   wherein
the cover portion is attached to the container portion and, in a closed state, contacts the container wall and the segmenting structure, thereby closing the at least three segments of the inner lumen of the container portion; and wherein
the opening means, or more specifically the opening means of the container portion, is adapted to partially remove the cover portion from the container wall and/or the segmenting structure, thereby opening the at least three segments of the inner lumen of the container portion to dispense the flowable pharmaceutical or nutraceutical compositions contained therein into the mixing vessel.

Said cartridge according to the first aspect of the invention may contain the at least three flowable pharmaceutical or nutraceutical compositions it is adapted to dispense into the mixing vessel.

In a second aspect, the invention provides for a mixing vessel for the preparation of a liquid pharmaceutical or nutraceutical formulation, preferably comprising at least two active pharmaceutical ingredients and at least one excipient, wherein the mixing vessel comprises a receptacle and a cap, wherein the receptacle and the cap can be releasably connected with each other, and wherein the receptacle comprises means for receiving the cartridge of the first aspect of the invention, and wherein the receptacle and/or the cap comprise opening means (of the mixing vessel) for bringing the cartridge received in the receptacle to an opened state by physical interaction with the opening means of the cartridge, or more specifically with the opening means of the container portion thereof.

In a third aspect, the invention relates to a kit comprising the cartridge according to the first aspect of the invention and a matching mixing vessel for preparing a liquid pharmaceutical or nutraceutical formulation, preferably comprising the at least two active pharmaceutical ingredients and the at least one excipient, according to the second aspect of the invention.

In a fourth aspect, the invention provides for a method for preparing a liquid pharmaceutical or nutraceutical formulation, preferably comprising at least two active pharmaceutical ingredients and at least one excipient, the method comprising the steps of:
a) providing a cartridge according to the first aspect of the invention;
b) providing a mixing vessel according to the second aspect of the invention;
c) optionally filling the receptacle of the mixing vessel with an aqueous liquid;
d) connecting the cartridge and the receptacle of the mixing vessel, preferably attaching or inserting the cartridge onto or into the receptacle of the mixing vessel;
e) connecting the receptacle with the cap of the mixing vessel, and
f) bringing the cartridge in an opened state, specifically by closing the receptacle by the cap of the mixing vessel.

In a fifth aspect, the present invention also refers to a liquid pharmaceutical or nutraceutical formulation, preferably comprising at least two active pharmaceutical ingredients and at least one excipient, obtained or obtainable by the method according to the fourth aspect of the invention.

In a sixth aspect, the present invention provides a method for the manufacture of a cartridge according to the first aspect of the invention, the method comprising the steps of:
a₁) providing the container portion of the cartridge according to the first aspect of the invention;
b₁) selectively filling the at least three segments of the inner lumen of the container portion with the at least three flowable pharmaceutical or nutraceutical compositions, specifically comprising at least two active pharmaceutical ingredients and at least one excipient; and
c₁) closing the filled container portion of the cartridge with the cover portion.

### BRIEF DESCRIPTION OF THE DRAWINGS

FIG. 1a shows a three-dimensional perspective view of a cartridge of the present invention with six segments and the cover portion removed;

FIG. 1b shows a three-dimensional perspective top-view of a cover portion corresponding to the cartridge as depicted in FIG. 1a;

FIG. 1c shows a three-dimensional perspective view of the bottom side of the cover portion as depicted in FIG. 1b;

FIGS. 2a to 2f show two-dimensional representations of specific segmenting structures of the cartridge of the present invention;

FIG. 3 shows a two-dimensional side view of the cartridge of FIG. 1a;

FIG. 4 shows an enlarged cross-sectional view of the opening means of the container portion;

FIG. 4a shows the opening means of FIG. 4 in the closed state (identical to FIG. 4);

FIG. 4b shows the opening means of FIG. 4 in the opened state;

FIG. 5 shows a three-dimensional perspective view of the cartridge of the present invention with the cover portion in an opened state;

FIG. 6 shows a three-dimensional perspective view of the cartridge of the present invention with the cover portion being covered by a sealing foil;

FIG. 7 shows a three-dimensional perspective view of the mixing vessel with receptacle and cap detached from each other and the cartridge mounted on the receptacle with the help of the means for receiving the cartridge;

FIG. 8a shows a cross-sectional view of the mixing vessel with the cartridge inserted and the cartridge being in a closed state;

FIG. 8b shows a cross-sectional view of the mixing vessel with the cartridge inserted and the cartridge being in an opened state.

### DETAILED DESCRIPTION OF THE INVENTION

In a first aspect, the present invention provides a cartridge for the preparation of a liquid pharmaceutical or nutraceutical formulation, the cartridge being adapted for insertion into a mixing vessel and for dispensing at least three flowable pharmaceutical or nutraceutical compositions into said mixing vessel, the cartridge comprising a container portion, a cover portion and an opening means, or more specifically an opening means of the container portion, for opening the cartridge, or in other words for bringing the cartridge to an opened state, preferably after its insertion into the mixing vessel,

wherein
the container portion comprises
   a) a container wall and a container base, the container wall and the container base defining an inner lumen and an opening of the container portion, the opening being positioned opposite to the container base, and
   b) a segmenting structure located in the inner lumen of the container portion and being physically connected to the container wall and/or to the container base such as to divide the inner lumen of the container portion into at least three segments containing the at least three flowable pharmaceutical or nutraceutical compositions; and
      wherein
the cover portion is attached to the container portion and, in a closed state, contacts the container wall and the segmenting structure, thereby closing the at least three segments of the inner lumen of the container portion; and wherein
the opening means, or more specifically the opening means of the container portion, is adapted to partially remove the cover portion from the container wall and/or the segmenting structure, thereby opening the at least three segments of the inner lumen of the container portion to dispense the flowable pharmaceutical or nutraceutical compositions contained therein into the mixing vessel.

The cartridge according to this first aspect of the present invention is suitable for the preparation of a liquid formulation, or, more specifically, a liquid pharmaceutical or nutraceutical or other formulation suitable for oral administration to a human or animal, preferably, however, for oral administration to, or consumption by, a human or patient in need thereof. The terms ‘pharmaceutical or nutraceutical’ as used herein are to be understood in a broad and non-limiting manner and, in the broadest sense and unless where expressly stated otherwise, refer to a formulation or composition comprising ingredients or compounds, more specifically active ingredients, nutritive substances, foodstuffs, or other consumable matter of natural, non-natural, synthetic or semi-synthetic origin that are suitable for administration to a human or animal. In more specific embodiments, such pharmaceutical or nutraceutical compositions are suitable for oral administration to an animal or human, preferably to a human.

With regard to the cartridge according to this first aspect of the present invention, it should be understood that the present invention is not limited to a cartridge being adapted to be suitable for dispensing the at least three flowable pharmaceutical or nutraceutical compositions, but is also meant to include, or encompass, the cartridge actually containing—and, upon use of said cartridge actually dispensing—the at least three flowable pharmaceutical or nutraceutical compositions. Same applies accordingly to any embodiments, or specific or preferred embodiments, disclosed herein in connection with the cartridge of the present invention; also, and in particular, to any embodiments detailing further preferences regarding the specifics of the at least three flowable pharmaceutical or nutraceutical compositions.

In other words, in one of the preferred embodiments, the present invention provides a cartridge for the preparation of a liquid pharmaceutical or nutraceutical formulation, the cartridge being adapted for insertion into a mixing vessel and for dispensing at least three flowable pharmaceutical or nutraceutical compositions into said mixing vessel, the cartridge comprising a container portion, a cover portion and an opening means, or more specifically an opening means of the container portion, for opening the cartridge, preferably after its insertion into the mixing vessel, wherein
the container portion comprises
   a) a container wall and a container base, the container wall and the container base defining an inner lumen and an opening of the container portion, the opening being positioned opposite to the container base, and
   b) a segmenting structure located in the inner lumen of the container portion and being physically connected to the container wall and/or to the container base such as to divide the inner lumen of the container portion into at least three segments containing the at least three flowable pharmaceutical or nutraceutical compositions; and
      wherein
the cover portion is attached to the container portion and, in a closed state, contacts the container wall and the segmenting structure, thereby closing the at least three segments of the inner lumen of the container portion; and wherein
the opening means, or more specifically the opening means of the container portion, is adapted to partially remove the cover portion from the container wall and/or the segmenting structure, thereby opening the at least three segments of the inner lumen of the container portion to dispense the flowable pharmaceutical or nutraceutical compositions contained therein into the mixing vessel; and wherein the cartridge contains the at least three flowable pharmaceutical or nutraceutical compositions.

Furthermore the term ‘liquid’ as used herein in connection with the pharmaceutical or nutraceutical composition that may be prepared using the cartridge according to the present invention is also to be understood in a broad sense and describes a composition which is not solid and which is not gaseous and accordingly comprises liquids irrespective of the degree of viscosity. Accordingly, the term ‘liquid’ as referred to herein may be a fluid material capable of altering its shape to that of a container which holds the liquid but retains a nearly constant volume independent of pressure. A liquid may represent a monophasic liquid solution or a dispersion with a continuous liquid phase and a dispersed phase which may, or may not, be liquid. A liquid may represent a monophasic liquid solution, or a dispersion with a continuous liquid phase and a dispersed phase which may, or may not, be liquid. More specifically a ‘liquid composition’ according to the present invention may be a composition, more specifically a solution, suspension or dispersion (the latter comprising liquid particles or droplets or finely divided solid material), irrespective of the degree of viscosity, e.g. liquids or semi-solid compositions with a very high viscosity. In preferred embodiments, however, the term ‘liquid’ refers to a composition which has a viscosity suitable for oral intake. In further specific embodiments, especially in connection with the formulations meant to be prepared using the cartridge of the present invention, the term ‘liquid’ composition refers to a solution, suspension or dispersion in which the pharmaceutical or nutraceutical components or compositions to be administered are dissolved, or at least partly dissolved, or evenly suspended or dispersed, as described above.

The cartridge according to the present invention may also be described in broad terms as a ‘dispensing device’, ‘replaceable container’ or ‘capsule’, such as a capsule as commonly used for the preparation of hot and cold beverages. More specifically, the term cartridge as used herein refers to a container, more specifically a closed container, which is adapted for insertion into a mixing vessel as described in further detail below. For this purpose, in one of the preferred embodiments, the mixing vessel, vice versa, is also adapted in that it comprises means for receiving the cartridge, or, in other words, means into which the cartridge can be inserted. Furthermore, the cartridge according to the present invention is adapted or suitable for dispensing at least three flowable pharmaceutical or nutraceutical compositions into said mixing vessel, more specially after connection with, or insertion of the cartridge into the mixing vessel. As mentioned above, the present invention also includes, or encompasses, the cartridge actually containing—and, upon insertion of the cartridge into the mixing vessel, dispensing—the at least three flowable pharmaceutical or nutraceutical compositions.

The term ‘flowable’ pharmaceutical or nutraceutical compositions is also to be interpreted in a broad sense as describing a composition, more specifically a pharmaceutical or nutraceutical composition which is present or provided in a physical form, shape, or more specifically dosage form, that allows for the efficient and preferably complete transfer of such a composition once introduced in a container or, more specifically in the cartridge of the present invention, by pouring or emptying, e.g. after opening of said container and turning it so that the composition can exit the container or cartridge due to the force of gravity. This understanding of the compositions' flowability, of course, applies irrespective of whether the cartridge is opened manually (e.g. by deliberately removing any sealing foils and the cover portion from the cartridge's container portion), or whether it is opened in the preferred manner of the invention, namely after insertion into a mixing vessel, and in physical conjunction, or physical interaction, therewith.

In specific embodiments, the at least three flowable pharmaceutical or nutraceutical compositions may be provided in any suitable form that allows for dispensing such composition as described above, and that furthermore allows and is suitable for the administration and formulation of active pharmaceutical or nutraceutical ingredients, excipients and further constituents suitable especially for oral administration. Examples of suitable forms of the pharmaceutical or nutraceutical compositions include liquid dosage forms such as solutions, suspensions or dispersions, or active ingredients which are already liquids per se, as well as solid dosage forms such as tablets, capsules (two-piece hard capsules, single-piece soft capsules), minitablets, granules, pellets (i.e. granules of essentially roun(ed) shapes; e.g. spheronized granules), and powders. In further specific embodiments, the at least three flowable compositions may be provided in form of powders, granules, pellets, or in form of a liquid, either in form of a liquid substance as such, or in form of a solution, suspension or dispersion. When provided in particulate form, e.g. in form powders, granules or pellets, the size of the respective particles is not critical as long as such particulate material can be poured from the cartridge as described above. Similarly, a suitable pharmaceutical or nutraceutical composition may also be provided in the form of just one larger granule, tablet, pill or pellet (rather than as multiple smaller particles) comprising the whole amount of the pharmaceutical or nutraceutical compound or component to be administered, as long as such singular particle has a size that allows for exiting the container, or cartridge, as described above. In case of solid dosage forms, but particularly in case of granules or pellets, the individual particle(s) may be coated or uncoated.

For a particulate material such as a powder, pellets or granules, for example, typical particle sizes would be within the range of from about 1 μm to about 25 mm, or in the case of a powder in the range of from about 1 μm to about 500 μm, or in the case of pellets or granules in the range of from about 100 μm to about 1500 μm, or in the case of larger particles like tablets, minitablets or coated tablets in the range of from about 0.5 mm to about 25 mm. It should be understood that these particle size provisions apply to the particles of the pharmaceutical or nutraceutical compositions as stored in, and emptied out from, the cartridge into the mixing vessel, not to the particle sizes in the final pharmaceutical or nutraceutical formulation obtained in the mixing vessel. Especially in cases where the final pharmaceutical or nutraceutical formulation formed in the mixing vessel is a suspension (i.e. a solid inner phase of particles dispersed in a liquid or semisolid outer phase), the size of the suspended particles should preferably not exceed 600 μm, more preferably not exceed 500 μm such as to avoid unpleasant foreign body sensations in the mouth- and throat region upon oral ingestion of the pharmaceutical or nutraceutical formulation.

In specific embodiments, at least one of the at least three flowable pharmaceutical or nutraceutical compositions is provided in the form of a powder, pellets, granules or other particulate material. In further specific embodiments, two or three or four or five or six of the at least three flowable pharmaceutical or nutraceutical compositions are provided in the form of a powder, granules or other particulate material. In some embodiments, all of the flowable pharmaceutical or nutraceutical compositions are provided in form of powder, pellets, granules or other particulate materials.

In preferred embodiments, the at least three flowable pharmaceutical or nutraceutical compositions to be dispensed by the cartridge according to the present invention combined comprise at least two active pharmaceutical ingredients. The term ‘active pharmaceutical ingredient’ or ‘API’ as used herein may be an active agent, therapeutic agent, active principle, drug, bioactive agent, and, in the broadest sense, refers to a compound or combination of compounds which are pharmaceutically active against an undesired condition; examples of suitable active pharmaceutical ingredients are detailed further below. The at least two active pharmaceutical ingredients can be comprised either altogether in one of the at least three pharmaceutical or nutraceutical compositions; or the at least two, or three, or four, or five, or six, or even more active pharmaceutical ingredients can be comprised by more than one of the at least three pharmaceutical or nutraceutical compositions. Accordingly, it may be possible that one of the at least three pharmaceutical or nutraceutical compositions can comprise more than one active pharmaceutical ingredient while others of the at least three pharmaceutical or nutraceutical compositions do not comprise an active pharmaceutical ingredient. In specific embodiments, each of the at least two active pharmaceutical ingredients is present in, or comprised by, only one of the at least three pharmaceutical or nutraceutical compositions.

In further specific embodiments, the at least three flowable pharmaceutical or nutraceutical compositions combined comprise at least one excipient. The term ‘excipient’, or ‘pharmaceutical excipient’, as used herein is to be interpreted in a broad sense and refers to a substance other than an active pharmaceutical ingredient (API) that is comprised by the pharmaceutical or nutraceutical composition and has been appropriately evaluated for safety and is intentionally included in the pharmaceutical or nutraceutical composition. While the excipient is often chosen in order to favourably influence the pharmacokinetic behaviour of the active pharmaceutical ingredient with which it is combined, excipients are typically characterised by not exhibiting a pharmacologic effect themselves, and are thus sometimes also referred to as being ‘inert’. Examples of excipients comprise but are not limited to thickeners, wetting agents, antifoaming agents, fillers, diluents, buffers, pH adjusting agents, osmolarity adjusting agents, antiadherents, binders, plasticizers, coatings, colors, disintegrants, flavors, glidants, lubricants, preservatives, sorbents, sweeteners, vehicles and the like.

In specific embodiments, the at least three flowable pharmaceutical or nutraceutical compositions combined comprise at least two active pharmaceutical ingredients and at least one excipient. However, it should be noted that the number of active pharmaceutical ingredients and excipients is theoretically not limited, or only limited by, or due to, the number of flowable pharmaceutical or nutraceutical compositions which are present in the cartridge, or, in other words, which can be stored in the container portion of the cartridge, preferably separately from each other in different segments of the container portion. Accordingly, it may be possible that the at least three pharmaceutical or nutraceutical compositions combined comprise three, four, five, six, seven, eight, or even more different active pharmaceutical ingredients, such as up to 10 or 12, or even more different active pharmaceutical ingredients. In many cases, however, the at least three pharmaceutical or nutraceutical compositions combined comprise from two to six different active pharmaceutical ingredients, often from two to four, or two, or three different active pharmaceutical ingredients.

Furthermore, in specific embodiments, it may be possible that the at least three pharmaceutical or nutraceutical compositions combined comprise one or more than one different excipients such as one, or two, or three, or four, or five, or six, or seven, or eight, or even more different excipients. In many cases, however, the at least three pharmaceutical or nutraceutical compositions combined comprise one or from two to about six different excipients.

The number of the active pharmaceutical ingredients and the number of excipients as described above can be varied independently of each other. Accordingly, it may be possible that the at least three pharmaceutical or nutraceutical compositions combined comprise for example, two, or three, or four active pharmaceutical ingredients as well as, for example, two, or three, or four excipients. Again, it should be noted, that the chosen number of active pharmaceutical ingredients and the chosen number of excipients can be independently distributed over the chosen number of the at least three pharmaceutical or nutraceutical compositions.

In specific embodiments, however, each of the at least two active pharmaceutical ingredients is present in, or comprised by, only one of the at least three flowable pharmaceutical or nutraceutical compositions, as mentioned above. In further specific embodiments, at least one of the at least three flowable pharmaceutical or nutraceutical compositions does not comprise an active pharmaceutical ingredient. Such a flowable pharmaceutical or nutraceutical composition is hereinafter also referred to as an ‘excipient composition’, i.e. a composition which does not comprise an active pharmaceutical ingredient but only one or a plurality of different excipient(s), such as two, or three, or four, or five, or six different pharmaceutical excipients. In that regard, it should be understood that the expression ‘pharmaceutical or nutraceutical composition’ refers to any of the at least three flowable compositions stored inside, and dispensed by, the cartridge which is used, or required for, the preparation of the intended liquid pharmaceutical or nutraceutical formulation in the mixing vessel. In other words, the expression alone, does not necessarily imply the presence of an active ingredient in all of the at least three pharmaceutical or nutraceutical flowable compositions.

In further specific embodiments, each of said at least three flowable pharmaceutical or nutraceutical compositions, e.g. each of the three, or four, or five, or six, specifically the three, or four, or five, or the three or four, or the three pharmaceutical or nutraceutical compositions, is different from the others. In further specific embodiments, at least two of the at least three flowable pharmaceutical or nutraceutical compositions comprise at least one active pharmaceutical ingredient, or just one active pharmaceutical ingredient, and optionally further one or more different excipients. In further specific embodiments, two of the at least three, or two of the three, flowable pharmaceutical or nutraceutical compositions comprise an active pharmaceutical ingredient, preferably just one active pharmaceutical ingredient, and at least one, or one of the at least three, flowable composition(s) comprises an excipient but no active pharmaceutical ingredient.

In further specific embodiments, two of the at least three, e.g. of the four, or five, or six flowable pharmaceutical or nutraceutical compositions comprise an active pharmaceutical ingredient, and at least one further pharmaceutical or nutraceutical composition does not comprise an active pharmaceutical ingredient but only at least one excipient. Further possible combinations will be apparent and described further below in connection with the description of the container portion of the cartridge.

The at least three pharmaceutical or nutraceutical compositions to be stored and dispensed by the cartridge according to the present invention may comprise active pharmaceutical ingredients. In preferred embodiments, as described in detail above, the at least three pharmaceutical or nutraceutical composition combined may comprise at least two different active pharmaceutical ingredients. These active pharmaceutical ingredients or, in other words, pharmaceutically active compounds, or drug compounds, may be selected from a broad range of such compounds known to those of skill in the art. It should be noted that no structural limitations apply with regard to the selections of such a compound, in particular, as long as no detrimental interactions, for instance, between the compound and the materials of the cartridge and/or the mixing vessel, occur, or are likely to occur. Furthermore, in principle no limitations apply with regard to the indication, mode of action or other general considerations. Furthermore, especially in cases in which each of the at least three flowable pharmaceutical or nutraceutical compositions comprises only one active pharmaceutical ingredient, no restrictions with regard to potential interactions between different active pharmaceutical ingredients apply, especially during transport and storage of the filled cartridges.

Accordingly, the active pharmaceutical ingredients present in the at least three pharmaceutical or nutraceutical compositions, preferably in at least two of the at least three pharmaceutical or nutraceutical compositions, can be selected from a broad variety of pharmaceutically active compounds. In exemplary, non-limiting embodiments, such active pharmaceutical ingredients may be selected from beta-blockers, such as bisoprolol, metoprolol, nebivolol or carvediol; angiotensin-converting enzyme (ACE) inhibitors such as ramipril, enalapril or lisinopril; diuretics such as torasemide, furosemide, hydrochlorothiazide or spironolactone; calcium channel blockers such as amlodipine, lercanidipine, nifedipin, verapamil or nitrendipine; oral anti-diabetic drugs such as metformin, sitagliptin or glimepiride; HMG-CoA reductase inhibitors (Statins) such as simvastatin, atorvastatin, pravastatin or fluvastatin; angiotensin receptor blockers such as candesartan, losartan or valsartan; proton pump inhibitors such as pantoprazole, omeprazole, esomeprazole or lansoprazole; antiplatelet drugs such as clopidrogel and pasugel; anticoagulant drugs such as rivaroxaban and apixaban; cholecalciferol against Vitamin D deficiency; alpha-blockers such as tamsulosin or doxazosin; antidepressants such as amitriptyline, opipramol, mirtazapine, citalopram, venlafaxine and sertraline; antiemetics such as metoclopramide; anticonvulsant such as levetiracetam, pregabalin, valproate or gabapentin; anti-inflammatory drugs such as methotrexate; anxiolytic drugs such as lorazepam; dopamine receptor agonists such as pramipexole; neuroleptics such as quetiapine, risperidone or melperone; antidementia drugs such as memantine or donepezil; analgesics such as acetylsalicylic acid, diclofenac, ibuprofen, paracetamol, etoricoxib or metamizole; mucoactive agents such as ambroxol, bromhexine, acetylcysteine, guaifenesin, and dornase alfa; antiparkinson drugs such as levodopa, selegiline or safinamide; sympathomimetic drugs such as moxonidine; xanthine oxidase inhibitor such as allopurinol, and many others more.

In one of the preferred embodiments, the at least three flowable pharmaceutical or nutraceutical compositions combined comprise at least two active pharmaceutical ingredients, and optionally at least one excipient; and at least one of said active pharmaceutical ingredients is selected from beta-blockers, angiotensin-converting enzyme (ACE) inhibitors, diuretics, calcium channel blockers, oral antidiabetic drugs, HMG-CoA reductase inhibitors (Statins), angiotensin receptor blockers, proton pump inhibitors, antiplatelet drugs, anticoagulant drugs, alpha-blockers, antidepressants, antiemetics, anticonvulsants, anti-inflammatory drugs, anxiolytic drugs, dopamine receptor agonists, neuroleptics, antidementia drugs, analgesics, mucoactive agents, antiparkinson drugs, sympathomimetic drugs, and xanthine oxidase inhibitors.

In one of the further preferred embodiments, the at least three flowable pharmaceutical or nutraceutical compositions combined comprise at least two active pharmaceutical ingredients, and optionally at least one excipient; and two or more, optionally all, of the at least two active pharmaceutical ingredients are selected from beta-blockers, angiotensin-converting enzyme (ACE) inhibitors, diuretics, calcium channel blockers, oral antidiabetic drugs, HMG-CoA reductase inhibitors (Statins), angiotensin receptor blockers, proton pump inhibitors, antiplatelet drugs, anticoagulant drugs, alpha-blockers, antidepressants, antiemetics, anticonvulsants, anti-inflammatory drugs, anxiolytic drugs, dopamine receptor agonists, neuroleptics, antidementia drugs, analgesics, mucoactive agents, antiparkinson drugs, sympathomimetic drugs, and xanthine oxidase inhibitors.

In one of the further preferred embodiments, the at least three flowable pharmaceutical or nutraceutical compositions combined comprise at least two active pharmaceutical ingredients, and optionally at least one excipient; and at least one of said active pharmaceutical ingredients is selected from beta-blockers, angiotensin-converting enzyme (ACE) inhibitors, diuretics, calcium channel blockers, oral antidiabetic drugs, HMG-CoA reductase inhibitors (Statins), angiotensin receptor blockers, proton pump inhibitors and anticoagulant drugs.

In one of the further preferred embodiments, the at least three flowable pharmaceutical or nutraceutical compositions combined comprise at least two active pharmaceutical ingredients, and optionally at least one excipient; and two or more, optionally all, of the at least two active pharmaceutical ingredients are selected from beta-blockers, angiotensin-converting enzyme (ACE) inhibitors, diuretics, calcium channel blockers, oral antidiabetic drugs, HMG-CoA reductase inhibitors (Statins), angiotensin receptor blockers, proton pump inhibitors and anticoagulant drugs.

As mentioned before, each of the at least two active pharmaceutical ingredients selected from the lists described above may optionally be present in, or comprised by, only one of the at least three flowable pharmaceutical or nutraceutical compositions; or they may be present combined in the same pharmaceutical or nutraceutical composition(s).

As mentioned earlier, there are no general limitations with regard to the active pharmaceutical or nutraceutical compounds to be administered and accordingly to be comprised by the at least three pharmaceutical or nutraceutical compositions according to the present invention. Such nutraceutical ingredients or compounds may, for example, be selected from vitamins such as vitamin A, vitamin C (ascorbic acid), vitamin D (e.g. cholecalciferol, ergocalciferol), vitamin E (tocopherols, tocotrienols), vitamin K₁ (phylloquinone), vitamin B₉ (folic acid), vitamin B₁₂ (cyanocobalamin, methylcobalamine), vitamin B₆ (pyridoxine), vitamin B₂ (riboflavin), vitamin B₅ (pantothenic acid), vitamin B₁ (thiamine), vitamin B₃ (niacin), vitamin B₇ (biotin) or derivatives thereof; minerals or trace elements such as calcium, iron, zinc, magnesium, selenium, cobalt, manganese, copper, fluorine, or iodine, or salts thereof; plant extracts such as fruit extracts; mushroom extracts; micro-nutrients including phytochemicals, such as terpenoids or polyphenolic compounds; organic acids; phytoalexines such as resveratrol; ubiquinol (Coenzym Q10); probiotics; prebiotics; and many others more.

The exemplary compounds as listed above are to be understood as non-limiting examples which may be replaced or supplemented by other active pharmaceutical ingredients or drug products known to those of skill in the art.

In a specific embodiment, the at least three flowable pharmaceutical or nutraceutical compositions combined comprise at least two active pharmaceutical ingredients, and optionally at least one excipient; and at least one of said active pharmaceutical ingredients is selected from beta-blockers, angiotensin-converting enzyme (ACE) inhibitors, diuretics, calcium channel blockers, oral antidiabetic drugs, HMG-CoA reductase inhibitors (Statins), angiotensin receptor blockers, proton pump inhibitors, antiplatelet drugs, anticoagulant drugs, alpha-blockers, antidepressants, antiemetics, anticonvulsants, anti-inflammatory drugs, anxiolytic drugs, dopamine receptor agonists, neuroleptics, antidementia drugs, analgesics, mucoactive agents, antiparkinson drugs, sympathomimetic drugs, and xanthine oxidase inhibitors, while the other(s) may be selected from vitamins, minerals or trace elements, plant extracts, mushroom extracts, micro-nutrients, organic acids, phytoalexines, probiotics, and prebiotics. Again, each of the at least two active pharmaceutical ingredients selected from the lists described in this paragraph may optionally be present in, or comprised by, only one of the at least three flowable pharmaceutical or nutraceutical compositions; or they may be present combined in the same pharmaceutical or nutraceutical composition(s).

In a further specific embodiment, the at least three flowable pharmaceutical or nutraceutical compositions combined comprise at least two active pharmaceutical ingredients, and optionally at least one excipient; and at least one of said active pharmaceutical ingredients is selected from anti-inflammatory drugs, analgesics, and mucoactive agents, while the other(s) may be selected from vitamins, minerals or trace elements, plant extracts, mushroom extracts, micro-nutrients, organic acids, phytoalexines, probiotics, and prebiotics. Again, each of the at least two active pharmaceutical ingredients selected from the lists described in this pagraph may optionally be present in, or comprised by, only one of the at least three flowable pharmaceutical or nutraceutical compositions; or they may be present combined in the same pharmaceutical or nutraceutical composition(s).

The at least three flowable pharmaceutical or nutraceutical compositions, and especially the pharmaceutical or nutraceutical composition that does not comprise an active ingredient (i.e. the excipient composition), comprise(s) at least one excipient as defined in general terms above. Such excipient, or excipients—which may, or may not, be also present in the at least two pharmaceutical or nutraceutical compositions that comprise at least one active pharmaceutical ingredient—may also be selected from a broad range of excipients or pharmaceutically acceptable additives known to those of skill in the art and as listed and summarized, for example, in: European Pharmacopoeia (Ph. Eur.), United States Pharmacopeia (USP), Handbook of Pharmaceutical Excipients, Generally recognized as safe (GRAS) substances database by United States Food and Drug Administration (FDA), or Fiedler: “Lexikon der Hilfsstoffe”, ECV Editio Cantor Verlag.

In specific embodiments, such excipients may be selected from, but are not limited to, thickeners, disintegrants, wetting agents, antifoaming agents, binders and diluents, buffers, and pH adjusting agents, osmolarity adjusting agents, antiadherents, plasticizers, colors, flavors, glidants, lubricants, preservatives, sorbents, sweeteners, and others.

In exemplary embodiments, the thickeners (or thickening agents) useful as an excipient in the context of the present invention may be selected from xanthan gum, carrageenan, tragacanth gum, gum guar, alginates, agar-agar, modified starch, carboxymethylcellulose, crystalline cellulose, alone or in combination with other hydrocolloids (e.g. AVICEL® RC-591 or AVICEL® CL-611 of FMC Corporation) and many others.

In yet further specific embodiments, the excipient(s) may be selected from the group of binders. Such binders may, for example, be selected from the group of water-soluble compounds like polyethylene glycols, polyvinyl alcohols, polyvinyl-pyrrolidone, and cellulose ethers such as methyl cellulose, hydroxypropylmethyl cellulose, hydroxyethyl cellulose or hydroxypropyl cellulose.

In specific preferred embodiments, the thickener (or thickening agent) and/or the binder, if present, may cause thixotropic properties of the resulting liquid pharmaceutical or nutraceutical formulation to be prepared according to the present invention upon mixing with water, or an aqueous vehicle, as described in further detail below. Exemplary thickeners causing such thixotropic properties are listed in the respective paragraph above.

In further specific embodiments, the disintegrants may, for example, be selected from sodium starch glycolate, croscarmellose sodium, crospovidone, low-substituted hydroxypropyl cellulose, and others. In preferred embodiments, these compounds may facilitate the dispersion and hydration of the thickeners and avoid their agglutination upon addition to the aqueous vehicle, respectively dispersant of the chosen active pharmaceutical ingredient(s) in water if present.

In further specific embodiments, the wetting agent (or surfactant) may, for example, be selected from dioctyl sodium sulphosuccinate, sodium laurylsulphate, sorbitol, and sorbitane esters with polyoxyethylene and fatty acids, such as sorbitane monolaurate, polyoxyethylen(20)-sorbitan-monolaureate, polyoxyethylen(20)-sorbitan-monooleat, polyoxyethylen(20)-sorbitan-tristearate and others. In preferred embodiments, these compounds may facilitate the solution, dispersion, or suspension of the chosen active pharmaceutical ingredient(s) in water, or an alternative aqueous, drinkable liquid, and the dissolution of the thickening agent if present.

In further specific embodiments, the excipient(s) may be selected from the group of antifoaming agents. Such antifoaming agents may be selected from water-insoluble oils like medium chain triglycerides (MCTs), polydimethylsiloxanes and other silicones such as Simeticon, alcohols such as poloxamer, and glycols such as polyethylene glycol for the preparation of an attractive solution, dispersions, or suspension of the chosen active pharmaceutical ingredient(s) in water, or other aqueous, drinkable liquid, without foam formation.

In further specific embodiments, the excipient(s) may be selected from the group of buffers or pH-adjusting agents. Such buffers or pH-adjusting agents may be selected from the group of anorganic or organic acids such as citric acid, lactic acid, fumaric acid, maleic acid, tartaric acid and others, and their respective buffer salts. The pH-adjusting agents and buffers may serve for the adjustment of the pH value of the aqueous medium which may have several advantages like stability, preferable comfort of administration and others. In addition, the anorganic or organic acids may also act as a flavor component, providing a fresh, acidic taste to the liquid pharmaceutical or nutraceutical compositions prepared in the mixing vessel.

In yet further specific embodiments, the excipient(s) may be selected from the group of inert diluents (also referred to as fillers), specifically solid inert diluents. Specifically, on such inert diluents, the thickener, the wetting agent and the antifoaming agent, if present, as well as optionally further constituents, may be applied, or absorbed, or adsorbed. Alternatively, the thickener, the wetting agent, the antifoaming agent, and optional further constituents, may simply be homogenously blended with the inert diluents. Inert diluents as described above may, for example, be selected from sucrose, lactose, levulose, mannitol, sorbitol, isomaltitol, maltodextrines, and microcrystalline cellulose, and others. Apart from serving as mere inert diluents, some diluents, especially the sugars or sugar alcohols, may also act as a flavor component, providing a sweet taste to the liquid pharmaceutical or nutraceutical compositions prepared in the mixing vessel

In a specific embodiment, the at least three flowable pharmaceutical or nutraceutical compositions combined comprise at least two active pharmaceutical ingredients, and optionally at least one excipient; and at least one of said active pharmaceutical ingredients is selected from beta-blockers, angiotensin-converting enzyme (ACE) inhibitors, diuretics, calcium channel blockers, oral antidiabetic drugs, HMG-CoA reductase inhibitors (Statins), angiotensin receptor blockers, proton pump inhibitors, antiplatelet drugs, anticoagulant drugs, alpha-blockers, antidepressants, antiemetics, anticonvulsants, anti-inflammatory drugs, anxiolytic drugs, dopamine receptor agonists, neuroleptics, antidementia drugs, analgesics, mucoactive agents, antiparkinson drugs, sympathomimetic drugs, and xanthine oxidase inhibitors; and at least one of said at least three flowable pharmaceutical or nutraceutical compositions does not comprise an active pharmaceutical ingredient (i.e. is an excipient composition). Optionally, two or more, or even all, of the at least two active pharmaceutical ingredients may be selected from the list provided in this paragraph. Further optionally, each of the at least two active pharmaceutical ingredients selected from said list may be present in, or comprised by, only one of the at least three flowable pharmaceutical or nutraceutical compositions; or they may be present combined in the same pharmaceutical or nutraceutical composition(s).

In a further specific embodiment, the at least three flowable pharmaceutical or nutraceutical compositions combined comprise at least two active pharmaceutical ingredients, and optionally at least one excipient; and at least one of said active pharmaceutical ingredients is selected from beta-blockers, angiotensin-converting enzyme (ACE) inhibitors, diuretics, calcium channel blockers, oral antidiabetic drugs, HMG-CoA reductase inhibitors (Statins), angiotensin receptor blockers, proton pump inhibitors, antiplatelet drugs, anticoagulant drugs, alpha-blockers, antidepressants, antiemetics, anticonvulsants, anti-inflammatory drugs, anxiolytic drugs, dopamine receptor agonists, neuroleptics, antidementia drugs, analgesics, mucoactive agents, antiparkinson drugs, sympathomimetic drugs, and xanthine oxidase inhibitors, while the other(s) may be selected from vitamins, minerals or trace elements, plant extracts, mushroom extracts, micro-nutrients, organic acids, phytoalexines, probiotics, and prebiotics; and at least one of said at least three flowable pharmaceutical or nutraceutical compositions does not comprise an active pharmaceutical ingredient (i.e. is an excipient composition). Again, each of the at least two active pharmaceutical ingredients selected from said list may be present in, or comprised by, only one of the at least three flowable pharmaceutical or nutraceutical compositions; or they may be present combined in the same pharmaceutical or nutraceutical composition(s).

In a yet further specific embodiment, the at least three flowable pharmaceutical or nutraceutical compositions combined comprise at least two active pharmaceutical ingredients, and optionally at least one excipient; and at least one of said active pharmaceutical ingredients is selected from anti-inflammatory drugs, analgesics, and mucoactive agents, while the other(s) may be selected from vitamins, minerals or trace elements, plant extracts, mushroom extracts, micro-nutrients, organic acids, phytoalexines, probiotics, and prebiotics; and at least one of said at least three flowable pharmaceutical or nutraceutical compositions does not comprise an active pharmaceutical ingredient (i.e. is an excipient composition). Again, each of the at least two active pharmaceutical ingredients selected from said list may be present in, or comprised by, only one of the at least three flowable pharmaceutical or nutraceutical compositions; or they may be present combined in the same pharmaceutical or nutraceutical composition(s).

The cartridge according to this first aspect of the present invention, in general, comprises three main structural and/or functional elements, namely a container portion, a cover portion and an opening means, or more specifically an opening means of the container portion (hereinafter referred to as the opening means of the container portion), for opening the cartridge, preferably, after its insertion into the mixing vessel.

The container portion comprises a container wall and a container base. The container base may also be understood as the bottom portion of the container which, in many cases, may have a flat, substantially flat, or structured shape which usually may serve as a base or platform on which the container can rest or stand in a stable manner on an even surface such as a table. The cartridge further comprises a container wall, or side wall, or circumferential wall, which is preferably attached to the container base, thereby forming, together with a container base a cup- or bowl-shaped receptacle. The generally cup- or bowl-shaped receptacle of the container portion of the cartridge is independent of the form of the container base and may have various shapes, such as irregular shapes, or regular shapes, or even symmetric shapes with regard to a normal central axis standing perpendicular on the container base as well as on the plane of the container opening being positioned opposite of the container base (herein after referred to as ‘normal axis’).

In specific embodiments, the container portion formed by the container base and the container wall may have a symmetrical form with regard to the normal axis of the container portion, such as a cylindric or tapered shape in case of a container base in the form of an oval or circle, or in the form of a cube or other angled cylinder, such as a quadrangular, pentagonal, hexagonal or other polygonal cylinder or tapered cylinder. In specific embodiments, the symmetry and/or shape of the container base matches the symmetry and/or shape of the container portion of the cartridge. Accordingly, it also possible to combine e.g. a circular container base with a cylindrical form of the sidewall. Accordingly, there are no general structural restrictions with regard to the shape or appearance of the container portion as long as it forms a tight receptacle suitable to hold the at least three pharmaceutical or nutraceutical compositions as described above.

The container wall and the container base of the container portion of the cartridge of the present invention define an inner lumen, or, in other words, a volume, cavity, or interior space with an opening. This opening is open to the surroundings of the container portion and allows for the charge and discharge (i.e. filling and emptying) of the contents of the container portion as described in further detail below. Specifically, the opening of the container portion is positioned opposite to the container base and accordingly, corresponds to the opening of the cup-or bowl-like structure of the container portion.

In the inner lumen, cavity, or inner space, or inner volume (hereinafter referred to as ‘inner lumen’) of the container portion, a segmenting structure is located. The segmenting structure may have the form of a dividing wall or plane, or, more specifically, of a plurality of dividing walls or planes which are attached, or physically connected, to the container wall and/or the container base (i.e. in some embodiments only to the container base, or only to the container wall) such as to divide the inner lumen of the container portion, preferably the entire inner lumen of the container portion into at least three segments. These segments, in preferred embodiments, are separated from each other and allow to hold the at least three flowable pharmaceutical or nutraceutical compositions to be dispensed by the cartridge of the present invention, preferably also in a separated manner. In specific embodiments of the cartridge according to the present invention, the segmenting structure is located in the inner lumen of the container portion and is physically connected to the container wall and/or to the container base such as to divide the entire inner lumen of the container portion into at least three segments containing the at least three flowable pharmaceutical or nutraceutical compositions. It should be pointed out that, in these embodiments, the entire inner lumen of the container portion is divided into the at least three segments holding the at least three pharmaceutical or nutraceutical compositions; or, in other words, all dividing walls span the whole distance from the container base up to the plane of the opening of the container portion positioned opposite said base. Accordingly, apart from the volume of the segmenting structure itself, the entire inner volume, or inner lumen, of the container portion can be used for the storage of the pharmaceutical or nutraceutical compositions to be dispensed; and no partial volume of the inner lumen of the container portion is necessary for, or blocked by, other elements of the cartridge, for example, by the opening means of the container portion.

The number of segments into which the inner lumen of the container portion may be divided may be varied in a broad range starting from at least three segments to a large number of segments which is only limited by practical considerations due to the decreasing size or volume of the resulting segments when a large number of segments is provided, taking into consideration that the sum of the lumen, or volumes, of the individual segments corresponds to the total volume of the inner lumen of the container portion. Accordingly, for practical purposes, the segmenting structure divides the inner lumen of the container portion into at least three, or four, or five, or six, or seven, or eight, or 10 segments; preferably, the segmenting structure divides the inner lumen of the container portion into three, four, five, or six segments.

Depending on the general construction of the segmenting structure, the resulting segments may, or may not, have an equal or roughly equal shape as well as an equal or roughly equal volume compared to one another. However, in specific embodiments, it is also possible that the segmenting structure divides the inner lumen of the container portion in a way that results in various and different sizes and shapes of the segments. In specific embodiments, however, the at least three segments, specifically the three to six segments, more specifically the three or four segments, or the three segments have an equal volume, or, more specifically, have an equal shape and volume. In exemplary embodiments, this would be the case if, for example, three or more, such as three, or four, or five, or six dividing walls would be provided in a cup- or bowl-like container portion, extending from the central main axis to the inner surface of the container wall and oriented at, or spaced from each other in, equal angles, thus resulting in a symmetrical star-shaped segmenting structure that would divide the inner lumen of a round, polygonal or other symmetrical container portion into equally shaped and sized segments.

In further exemplary embodiments, other assemblies of the dividing walls forming the segmenting structure are also conceivable, for example, concentric dividing walls which are attached to the container base only and divide the inner lumen of the container portion into a central segment and concentric outer segments of either same or different inner volumes. In yet further exemplary embodiments, the segmenting structure may have a grid like layout with segmenting walls crossing each other at either right or other angles.

In yet further exemplary embodiments, it is conceivable that two or more dividing walls (together forming the segmenting structure) are provided which are physically attached only to the sidewalls of the container portion and which do not have contact to the container base of the container portion; alike a backpack with a central main compartment and a number of small side pockets attached to the peripheral wall of said main compartment. This layout might especially be of interest (though not only then) in cases in which one larger and two or more smaller, or significantly smaller, segments are to be realized and the container portion has a tapered shape widening towards the opening of the container portion. However, even in these cases where the dividing walls have no contact to the container base, they still extend up to the opening of the container portion, or to the plane of said opening.

In specific embodiments, however, the segmenting structure is provided in form of dividing walls oriented perpendicular to the container base and perpendicular to the plane of the opening of the container portion, or, in other words, and in case the container portion is symmetrically shaped, parallel to the main central axis of the container portion as described above. In further specific embodiments, the segmenting structure is provided in form of at least three, such as three, or four, or five, or six dividing walls with a common symmetry axis (i.e. a star-shaped segmenting structure) which is oriented perpendicular to the container base and the plane of the opening of the container portion. In yet further specific embodiments, the container portion is symmetrically shaped, and the segmenting structure is provided in form of at least three, such as three, or four, or five, or six dividing walls with a common symmetry axis which is oriented perpendicular to the container base and the plane of the opening of the container portion, and parallel to the main central axis of the container portion. Optionally, the common symmetry axis of the star-shaped segmenting structure is identical with the central main axis of the container portion.

It should be pointed out again, however, that the size and shape and orientation of the segmenting structure can be varied within broad boundaries depending on the number and individual volumes of the resulting segments and in view of the shape of the container portion of the cartridge. The number of segments provided, however, may limit the number of different flowable pharmaceutical or nutraceutical compositions to be provided and dispensed by the cartridge according to the present invention. In general, it is possible, to provide each of the flowable pharmaceutical or nutraceutical compositions in one segment or in a plurality of segments, either alone or in combination with one or more further flowable pharmaceutical or nutraceutical composition.

In specific embodiments, however, each of the at least three segments contains one of the at least three flowable pharmaceutical or nutraceutical compositions, or, more specifically, exclusively contains one of the at least three flowable pharmaceutical or nutraceutical compositions. In further specific embodiments, each of said at least three flowable pharmaceutical or nutraceutical compositions is different from the other compositions present in the cartridge. As discussed above, the container portion of the cartridge which may be divided by the segmenting structure into a plurality of at least three segments, such as three, or four, or five, or six segments, and accordingly is adapted to dispense three, four, five, or six flowable pharmaceutical or nutraceutical compositions into the mixing vessel, respectively, also in cases in which each of the flowable pharmaceutical or nutraceutical compositions is exclusively provided in one segment.

In these preferred embodiments, the number of segments provided in the container portion of the cartridge equals the number of different flowable pharmaceutical or nutraceutical compositions to be dispensed by the cartridge. However, in general, it is possible, of course, that the number of segments provided in the container portion of the cartridge differs from the number of flowable pharmaceutical or nutraceutical compositions to be filled into, and dispensed by, said cartridge. For instance, cartridges comprising six segments, may nonetheless be filled with less than six flowable pharmaceutical or nutraceutical compositions; e.g. filling three compositions into three segments, preferably evenly spaced apart, and leaving the remaining three segments empty; or filling the three compositions into all six segments while allocating the number of segments per composition based on e.g. the volume required by each of those three compositions. Vice versa, it may be equally possible to fill four different pharmaceutical or nutraceutical compositions into a cartridge with a container portion housing only three segments; e.g. if at least two of the four compositions are compatible with one another and thus can be filled into, and stored in, one and the same segment, while the other two segments are each filled with one of the two remaining compositions.

In further specific embodiments, one of the segments contains a flowable pharmaceutical or nutraceutical composition that does not comprise an active pharmaceutical ingredient (i.e. an excipient composition), and wherein each of the other segments contains a pharmaceutical or nutraceutical composition comprising an active pharmaceutical ingredient, preferably comprising a different active pharmaceutical ingredient.

In an exemplary embodiment, the container portion of the cartridge according to the present invention comprises three segments, wherein two of the segments contain a flowable pharmaceutical or nutraceutical composition comprising an active pharmaceutical ingredient, and wherein one of the segments comprises a pharmaceutical or nutraceutical composition that does not comprise an active pharmaceutical ingredient (i.e. an excipient composition), and preferably wherein the active pharmaceutical ingredients comprised by the two pharmaceutical or nutraceutical compositions are different from each other. Of course, other combinations of flowable pharmaceutical or nutraceutical compositions comprising an active pharmaceutical ingredient with compositions that do not comprise an active pharmaceutical ingredient but only at least one excipient (excipient compositions) are conceivable, such as the combination of three different flowable pharmaceutical or nutraceutical compositions comprising an active pharmaceutical ingredient and one, or two or more, further composition(s) which do not comprise an active pharmaceutical ingredient but only at least one excipient. In preferred embodiments, however, at least one of the flowable pharmaceutical or nutraceutical compositions does not comprise an active pharmaceutical ingredient but only at least one excipient.

The cartridge according to this aspect of the present invention further comprises a cover portion, or cover, which is adapted to cover or, in other words, close the opening of the container portion and, accordingly, adapted to close the inner lumen of the container portion or, more specifically, the at least three segments of the inner lumen of the container portion to provide at least three closed segments. The term ‘closed’ as used herein with regard to the inner lumen of the container portion or the individual segments of the container portion means that these lumens or segments are closed sealingly, i.e. so that the flowable pharmaceutical or nutraceutical compositions contained therein cannot leak from these lumens or segments. Furthermore, the term ‘closed’ as used herein may be understood as a moisture- or gas-tight closure, preferably as a closure suitable to conserve aseptic, or even sterile, conditions. The cover portion, as described in further detail below, may, or may not, comprise further elements that may provide for tightening or sealing.

The cover portion is attached to the container portion and, in a closed state, sealingly contacts the container wall and the segmenting structure. Accordingly, in a closed state, the cover portion is in moisture- or gas-tight contact with the container wall and the segmenting structure, or, more specifically with the upper edges of the dividing walls of the segmenting structure, i.e. the edges of the diving walls directed towards, or facing, the opening of the container portion. In specific embodiments, the upper edges of the dividing walls of the segmenting structure correspond to, or roughly correspond to, the upper edge of the outer wall of the container portion forming the opening of the container portion, so that the upper edges of the dividing walls and the upper edges of the outer wall of the container portion at least roughly lie in the same plane or on the same level. Furthermore, in a closed state, the cover portion closes the at least three segments of the inner lumen of the container portion or, more specifically, closes each of the at least three, such as three, or four, or five, or six, or even more segments of the inner lumen of the container portion.

To ensure a moisture- or gas-tight contact, or closure of the segments of the container portion, it may be advantageous to provide sealing means adapted to provide a tight connection between the cover portion and the container portion, and especially between the upper edges of the dividing walls of the segmenting structure and the cover portion. Accordingly, in specific embodiments, the cover portion comprises additional sealing means sealing the connection between the cover portion and the dividing walls of the segmenting structure. This may help to prevent unintended mixing or contamination of the contents of either one of the at least three segments of the container portion with the contents of another segment and, accordingly, assures that the at least three flowable pharmaceutical or nutraceutical compositions are effectively separated from each other while the cartridge is in closed state, and irrespective of whether the cartridge is transported or stored standing upright on the container base or not. In specific embodiments, such additional sealing means may, for example, be in the form of sealing lips or ridges formed on an inner surface of the cover portion, which may correspond to, and be in contact with, the upper edges of the dividing walls of the segmenting structure, thereby effectively sealing the connection between the cover portion and the dividing walls of the segmenting structure. In another embodiment, the sealing means may be elastomeric sealing lips or ridges, which may preferably be attached to, and protrude from, the inner surface of the cover portion and which may correspond to, and be in contact with, the upper edges of the dividing walls of the segmenting structure, thereby effectively sealing the connection between the cover portion and the dividing wall of the segmenting structure.

These sealing lips or ridges can be shaped as ‘singular’ sealing means contacting the upper edges of the dividing walls from only one side, or they can preferably be shaped as ‘double’ sealing means contacting the upper edges of the dividing walls from both sides; for instance, a set of two sealing lips on either side of the upper edge of a dividing wall, or in the form of narrow U-shaped ‘guardrail’ for said upper edge.

As an optional alternative to sealing lips or ridges which are attached to, and protrude from, the inner surface of the cover portion (e.g. elastomeric sealing lips or ridges), or even in addition thereto, the inner surface may also be equipped with concave sealing means, i.e. small groves provided in the inner surface whose size and spacing corresponds to the upper edges of the dividing walls of the respective container portion, and thereby seals these upper edges when the cover portion is placed on the container portion.

Similar sealing means, as described above especially for the dividing walls, may, of course, also be provisioned to provide a moisture- or gas-tight contact between the upper edges of the container wall and the cover portion.

In specific embodiments, the cover portion may be held in place on top of the container portion by means of a cover portion locking means, optionally a releasable cover portion locking means such as a thread, a bayonet coupling, or a snap-fit mechanism. Alternatively, the cover portion may also be glued or welded onto the container portion. In fact any locking means may be suited to affix the cover portion to the container portion as long as it i) provides moisture- or gas-tight contact of the cover portion's inner surface with the container wall and the segmenting structure of the container portion, in the cartridge's closed state, and as long as it ii) allows for the segments, or flaps, of the cover portion to be partially removed, or detached, from the container wall and/or the segmenting structure by the opening means of the container portion, as described in more detail below.

In specific embodiments, the cover portion may also comprise a plurality of segments, preferably at least three segments, such as three, or four, or five, or six, or even more segments. These segments of the cover portion may, for example, be in the form of flaps as described in further detail below, the number of which may, or may not, correspond to the number of the at least three segments of the inner lumen of the container portion. The cover portion or, more specifically, the individual segments of the cover portion may be attached to, or brought in contact with, the container portion, preferably it may be detachably connected with the container portion.

Furthermore, the cartridge according to the present invention, or more specifically the container portion thereof, comprises opening means which are adapted to partially remove or detach the cover portion, or more specifically its segments, from the container wall and/or the segmenting structure. In that regard, it should be understood that when speaking of ‘the opening means of the container’ within the context of this invention, this is not meant broadly in the sense of ‘any means capable of opening the container portion, irrespective of its position’ but instead refers to an opening means which is a part of the container portion, preferably an integral part thereof, and which, as described above, is adapted to partially remove or detach the cover portion. By this partial removal or detachment, the at least three segments of the inner lumen of the container portion are opened, so that the at least three, or preferably all of the at least three, flowable pharmaceutical or nutraceutical compositions contained therein may be poured, or dispensed, into the mixing vessel as described in further detail below. It should be noted, however, that the cover portion, or more specifically the flaps of the cover portion, are detached partially from the container wall and/or the segmenting structure; preferably, partially detached from the container wall and completely detached from the segmenting structure. This has the effect that the cover portion, or more specifically the flaps of the cover portion, stay at least partially attached to, or in contact to, the container wall (e.g. to the upper edge of the container wall), however, are completely detached from the segmenting structure (e.g. detached from the upper edge of the segmenting structure's dividing walls).

The opening means of the container portion can be realized in various forms or by various mechanisms that allow for the complete, or at least partial, opening of preferably all of the segments of the inner lumen of the container portion. More specifically, such a mechanism is adapted for and allows the partial detachment or removal from the container wall and/or the segmenting structure to make sure that the cover portion, or parts of the cover portion such as the flaps, are detached from the cartridge, more specifically completely detached from the upper edges of the segmenting structure's dividing walls and partially detached from the container portion, or container wall, and then may fall into, or rather swivel open towards, the mixing vessel and/or the aqueous liquid contained therein for the preparation of the pharmaceutical or nutraceutical formulation.

In other words, since the cover portion, or more specifically the segments or flaps thereof, stay(s) at least partially attached to, or in contact with, the container wall during the opening operation, the flaps are ‘hinged’ at the position of the container wall (but physically connected to the cover portion), and can then swivel open similar to a ‘trapdoor’ once the flaps are detached from the dividing walls, thereby opening the cartridge's the segments and dispensing the pharmaceutical or nutraceutical compositions contained therein into the mixing vessel.

With regard to the expression ‘detachment or removal from the container wall and/or the segmenting structure’, it should be understood that this refers to an action which locally breaks the moisture- or gas-tight contact between the cover portion and the container portion, and thereby opens the inner lumen of the container portion. However, in one of the preferred embodiments, the cover portion is neither cut nor pierced in order for this (partial) detachment or removal from the container wall and/or the segmenting structure, and thus opening of the container portion, to occur.

In specific embodiments, the opening means of the cartridge of the present invention, more specifically the opening means of the container portion thereof, are located, preferably entirely located, outside of the inner lumen of the container portion of the cartridge. In these specific embodiments, apart from the volume of the segmenting structure itself, the entire inner volume of the inner lumen of the container portion can be used for the storage of the pharmaceutical or nutraceutical compositions to be dispensed as no partial volume of the inner lumen of the container part is necessary for, or blocked by, the opening means.

Advantageous opening means of the cartridge's container portion that may help to serve that purpose are disclosed in the earlier patent application CH-01567/17 the contents of which are incorporated herein by reference.

In summary thereof, in specific embodiments, the container wall of the cartridge of the present invention, or more specifically the container wall of the container portion thereof, may comprise an edge surrounding the opening of the container portion, and an upper skirt also surrounding the opening of the container portion, wherein the upper skirt is radially and outwardly spaced from the edge of the container wall, and wherein the cover portion is connected to, or held in contact with, the upper skirt surrounding the opening of the container portion. The upper skirt is attached to, or affixed to, the container wall by a hinging connector section. Such a hinging connector section may allow for the displacement of the upper skirt of the container portion relative to the upper edge of the container wall and to the opening means of the container portion in order to open the cartridge, i.e. to bring the cartridge, or capsule, from a closed state to an opened state.

In further specific embodiments, the opening means of the container portion may be located below the cover portion in the closed state, and may be displaced, e.g. pushed or pressed, outwardly in relation to the cover portion (i.e. in the direction of, or towards, the cover portion) when moving from the closed state into the opened state so as to open the cover portion, or segments thereof such as the flaps.

In further specific embodiments, the opening means of the container portion are formed by the edge of the container wall, which may be in sealing contact with an inner surface of the cover portion, at least while the cartridge is in closed state.

In some embodiments, said hinging connector section, or hinging connector portion, in the closed state and in a cross-sectional view, can have a substantially loop-shaped or U-shaped form, for instance, a single U-shape. In these cases, by a displacement or shift of the upper skirt of the container portion, the flaps of the cover portion open (e.g. due to a physical contact with a (stationary) opening means of a mixing vessel as will be described in further detail below), and the hinging connector portion preferably is stretched or straightened. Due to said stretching or straightening of the substantially loop- or U-shaped part of the hinging connector section, or hinging connector portion, it can also exert a restoring force that may facilitate a back-shift of the upper skirt of the container portion into the closed state. This ‘re-closure’ of the cover portion's segments (e.g. the flaps) can be advantageous for a cleaner removal of the cartridge from the mixing vessel after the cartridge was opened and its contents dispensed, since the opened flaps typically get wetted with the contents of the mixing vessel during mixing process. The maximum shift may approximately correspond to the length of the hinging connector section, i.e. approximately double the length of a wing of the loop- or U-shaped connector section.

In some embodiments, the hinging part of the connector section may be a flexible and/or elastic thinner portion of the connector section. Normally, the hinging part of the connector section is thinner than the thickness of the container wall. The container wall and the upper skirt may substantially have the same wall thickness. In some embodiments, the upper skirt of the container portion may have the form of a further wall which may be positioned essentially parallel to the container wall. The lower end of said further wall may be connected to the hinging connector section, or hinging connector portion. At the upper skirt of the container portion, or at the upper end of that further wall, respectively, a circumferential flange may be provided which is oriented outwardly, i.e. away from the container wall and/or the upper skirt in form of the further wall. In some embodiments, the upper skirt of the container portion may be integrally formed with the container wall. In further embodiments, it may be provided as a one-piece unit (i.e. integrally formed with the container wall) which may, for example, be manufactured by injection molding.

In specific embodiments, the cover portion of the cartridge of the present invention may comprise several flaps, such as two or more, specifically two to six flaps, which together form the cover that may close the inner lumen of the container portion, or the at least three segments of the container portion, respectively. In these embodiments, the cover portion may comprise a peripheral frame and at least 2 flaps, specifically 2 to 6 flaps, or 3 to 4 flaps attached to the frame, wherein each flap is attached to the frame by at least one separate hinge, or a plurality of separate hinges, per flap. Said ‘flap hinges’ of the cover portion facilitate the above-mentioned ‘swiveling motion’ of the cover portion's segments during the opening operation. They may, for instance, be provisioned in the form of a small indentation on the inner surface of the cover portion, positioned close to its inner perimeter and, typically, radially outside the circumferential contact line between the cover portion and the upper edge of the container wall. This indentation—which can e.g. be continuous, dashed or dotted line—serves as a kind of predetermined bending line, or hinge, for the cover portion's flaps by appropriately weakening the material strength of the cover portion at that site. Alternative means of ‘hinging’ the flaps of the cover portion to the peripheral frame thereof may, of course, also be used.

In specific embodiments, the upper edge of the container wall can form the opening means. In these cases, for example, the opening means of the container portion can be arranged and adapted to displace, or push open, the plurality of flaps of the cover portion, bending, or rotating, them around their respective flap hinges and allowing the flaps to open, or swivel open. In specific embodiments, such a displacement of the flaps of the cover portion to open the cartridge according to the present invention is preferably effected by physical interaction with the mixing vessel, specifically, after connection of the cartridge according to the present invention with the mixing vessel as described in further detail below, or, more specifically, after insertion of said cartridge into the receiving means of said mixing vessel. In further specific embodiments, the closing of the mixing vessel effects the displacement of the plurality of flaps to open the cartridge; for instance, when closing the mixing vessel with its respective cap, e.g. by screwing on a screw cap. In further specific embodiments, especially when the flaps remain attached to, or in moisture- or gas-tight contact with, the container wall, and affixed to the cover portion by a flap hinging connection, during the opening step, the opening step of the container portion occurs starting from the center region of the cover portion, or the the center region of the opening of the container portion, respectively. However, as mentioned above, in one of the preferred embodiments, the cover portion, or respectively the segments thereof (e.g. the flaps), is/are neither cut nor pierced in order for the opening of the container portion to occur; hence, in this embodiment, the upper edge of the container wall forms the opening means but it is free of any cutting means or piercing means. The opening of the container portion preferably occurs as a result of a lever action, or prying effect, acting onto the cover portion when the cartridge physically interacts with the mixing vessel.

In specific embodiments, the at least two flaps, preferably the two to six flaps, are generated, or formed, by at least one trench in the cover portion. In exemplary embodiments, especially when the opening of the container portion has a circular form, the flaps may have the form of segments, or sectors, of the circle which may preferably be oriented such that the tips of the flaps meet at the central main axis of the cartridge as described above (at least if there are three or more flaps provided). In further specific embodiments, the at least two flaps have an equal size and shape; for instance, two flaps may be provided as the diameter segments of the circle (i.e. two semicircles), whereas more than two flaps, such as three, or four, or five, or six, or more than six flaps, may be provided as the respective number of equally sized sectors of the circle. In further specific embodiments, the number of flaps equals the number of segments of the container portion. In yet further specific embodiments, the number, size and shape of the flaps equals the number, size and shape of the segments of the container portion in the plane of the container portion's opening, so that the flaps correspond to the segments of the container portion, with each one of the flaps then covering, or closing, one of said segments by moisture- or gas-tight contact.

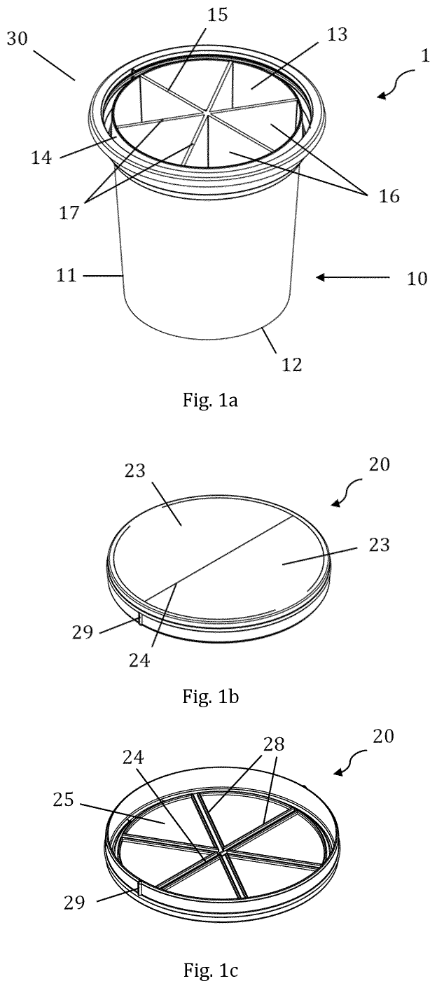

In alternative embodiments, the number of flaps differs from the number of segments of the container portion; for instance, a cover portion with two flaps could comprise sealing means that correspond to six segments of the container portion. In yet further specific embodiments, the number, size and shape of the flaps differs from the number, size and shape of the segments of the container portion in the plane of the container portion's opening; for instance, a cover portion with two semicircular flaps could comprise sealing means that correspond to six segments of the container portion shaped as equally sized sectors of a circle (as illustrated in FIG. 1a-c).

In some embodiments, the opening means of the container portion preferably comprises, or is formed by, the upper edge of the container wall of the container portion which comprises, at its front, a stop surface which contacts or, more specifically, presses onto the plurality of flaps of the cover portion upon insertion of the cartridge into the mixing vessel or, preferably, upon closing of the mixing vessel, thereby effecting the displacement or, more specifically, the opening of the flaps. In specific embodiments, the stop surface may be in the form of a plurality stop surfaces. In preferred embodiments, the stop surface, or the plurality of stop surfaces, may be arranged ring-shaped, wherein usually each stop surface may be in a position radially closer to the central main axis of the container portion with regard to the corresponding hinging connector section, or hinging connector portion. In other words, the diameter of a ring-shaped stop surface, or of a plurality of stop surfaces arranged in a ring-shaped manner, is smaller than the distance of the hinging connector section, or hinging connector portion, to the central main axis of the container portion. In preferred embodiments, however, the difference between these distances is small, however large enough to result in a leverage suitable to displace, or more specifically open, the flaps of the cover portion. This allows for the effective and complete opening, i.e. a displacement of the flaps by approximately 90° with regard to the position of the flaps in the closed state. In preferred embodiments, the flaps are displaced by at least 60° with regard to the initial position of the flaps in the closed state.

In specific embodiments, at least in a partially opened state, the flaps may form a slide, or chute, for the at least three flowable pharmaceutical or nutraceutical compositions to be dispensed from the cartridge. This allows for the guidance of the at least three flowable pharmaceutical or nutraceutical compositions towards the center region of the receptacle of the mixing vessel as described below and may help to avoid the contact with the wall of the receptacle which may otherwise potentially interfere with the dissolution/mixing process.

In further embodiments, the cartridge of the present invention may further comprise a sealing foil, preferably a detachable sealing foil that may further cover the cover portion and, accordingly, may provide for enhanced protection of the cartridge and the pharmaceutical or nutraceutical compositions contained therein, as well as of the cover portion itself, especially the outer surface of the cover portion. Accordingly, in one embodiment, the sealing foil may be attached to a circumferential flange of the container portion. In specific embodiments, the cover portion has an inner surface facing the inner lumen of the container portion and an outer surface facing the outside of the cartridge, and the cover portion comprises, or is covered by, a detachable sealing foil attached to the outer surface of the cover portion.

In specific embodiments, the sealing foil may be detachably attached to the outer surface of the cover portion, or, more specifically to the outer surface of the flaps of the cover portion. For example, the sealing foil may be glued or welded on the outer surface of the cover portion. In preferred embodiments, the sealing foil is detachably attached to the outer surface of the flaps of the cover portion and may comprise means that allow for the removal of the sealing foil prior to the usage of the cartridge of the present invention (e.g. prior to inserting said cartridge into the mixing vessel). Such means may, for example, comprise an extra piece of sealing foil extending beyond the surface of the cover portion to be sealed that allows to pull and detract the sealing foil (a so-called pull-tab). In other embodiments, for example, a grip, or handle, may be attached to the outer surface of the sealing foil, preferably close to the outer edge of the covered surface area, that may serve the same purpose.

In preferred embodiments, the sealing foil is made from a material that allows for both easy removal in one piece (e.g. simply peeling it off) and the effective protection of the outer surface of the cover portion, or, more specifically, of the outer surface of the flaps of the cover portion, to avoid any contamination of the outer surface of the flaps (e.g. during packaging of the cartridges, or shipping and storage). This is preferable, in particular for aseptically filled-in compositions (as usually the case with pharmaceutical or nutraceutical compositions), in that the outer surface of the flaps may, in specific embodiments as described above, come into contact with the liquid pharmaceutical or nutraceutical formulation to be prepared using the cartridge of the present invention together with the mixing vessel as described in further detail below.

Such sealing foil may, in specific embodiments, be made from any suitable polymeric, preferably thermoplastic material such as polyethylene (PE), high-density polyethylene (HDPE), polypropylene (PP), or polyethylene terephthalate (PET). Furthermore, such sealing foil may be in the form of an aluminium foil, either as such, or in form of a layered or composite material with one or more of the above-mentioned polymeric materials. The sealing foil may contain an oxygen-barrier layer.

In specific advantageous embodiments, the container portion comprising the container wall, the container base and the segmenting structure of the cartridge according to the present invention are formed as a single piece, optionally by injection molding. In further specific embodiments, the container portion comprising the container wall, the container base and the segmenting structure as well as the cover portion, specifically the flaps of the cover portion, are formed as a single piece unit, preferably by injection moulding. Preferably, the container wall, the container base and/or the segmenting structure of the container portion, or the container portion comprising the container wall, the container base and the segmenting structure as well as the cover portion, specifically the flaps of the cover portion, are formed from a thermoplastic material such as polyethylene (PE), high-density polyethylene (HDPE), polypropylene (PP) or polyethylene terephthalate (PET), polystyrene (PS), degradable polylactic acid (PLA) and others.

As described in detail above, the container portion of the cartridge of the present invention comprises at least three segments to hold and dispense the at least three flowable pharmaceutical or nutraceutical compositions. Depending on the degree of the flowability these compositions, as well as on the absolute and relative size, volume and shape of the segments of the container portion, it might be difficult to dispense these compositions from the segments in a timely and effective manner. For example, in case of certain liquid to semi-liquid compositions, it might be difficult to dispense such compositions completely in a timely manner due to their viscosity; or, in other words, certain viscous compositions simply flow, or drop, too slowly for convenient emptying from the cartridge. In case of solid compositions, on the other hand, for example, in case of solid compositions in the form of powders or fine granules, it might be difficult to fully dispense these materials due to static effects between the container or segmenting structure and such finely divided particulate material; or, in other words, certain solid compositions, such as powders or fine granules, may statically adhere to the container portion and/or the cover portion.

Accordingly, in specific embodiments of the cartridge, or, more specifically, of the container portion of the cartridge, the inner surface of the container portion and/or the surfaces of the segmenting structure (exposed to the at least three flowable pharmaceutical or nutraceutical compositions) are coated with a non-stick coating. The term ‘non-stick coating’, as used herein, should be understood in the broadest sense as defining a coating that reduces any interaction between the surfaces that might come into contact with the pharmaceutical or nutraceutical compositions to be dispensed and such compositions, including adhesive interactions, friction and static interactions. In further specific embodiments, the inner surface of the container portion and/or the surfaces of the segmenting structure and/or the inner surfaces of the cover portion, specifically of the flaps of the cover portion, are at least partly coated with a non-stick coating. Such a non-stick coating may be applied to the entire surface or surfaces as described above, or, in some embodiments, only to one or more of these surfaces, wherein each of such surfaces may be entirely or only partly coated.

Suitable materials for such nonstick-coatings comprise, for example, friction reducing materials such as silicon dioxide, antistatic materials or antiadhesive materials.

In a second aspect, the present invention provides a mixing vessel for the preparation of a liquid pharmaceutical or nutraceutical formulation, preferably a liquid pharmaceutical or nutraceutical formulation comprising at least two active pharmaceutical ingredients and at least one excipient, wherein the mixing vessel comprises a receptacle and a cap, wherein the receptacle and the cap can be releasably connected to each other, and wherein the receptacle comprises means for receiving the cartridge of the first aspect of the invention, and wherein the receptacle and/or the cap comprise opening means (of the mixing vessel) for bringing the cartridge received in the receptacle to an opened state, or in other words for opening the cartridge, by physical interaction with the opening means of the cartridge, more specifically, the opening means of the container portion thereof.

The mixing vessel according to this aspect of the invention is suitable for the preparation of a liquid pharmaceutical or nutraceutical formulation, such as the liquid pharmaceutical or nutraceutical formulation to be prepared with the cartridge of the first aspect of the present invention, preferably, a liquid pharmaceutical or nutraceutical formulation for oral intake or administration. In specific embodiments, accordingly, the mixing vessel is suitable for a liquid pharmaceutical or nutraceutical formulation comprising at least two active pharmaceutical ingredients and at least one excipient, as described in further detail above.

The mixing vessel comprises a receptacle and a cap, wherein the receptacle and the cap can be releasably connected with each other by suitable connecting means (hereinafter referred to as ‘connecting means of the mixing vessel’). In specific embodiments, such connecting means can, for example, be a thread, a bayonet coupling a snap fit or any other mechanism that provides for a tight, especially moisture- or liquid-tight connection of the receptacle and the corresponding cap. Preferably, however, the receptacle and the cap can be connected to each other by a thread, or screw thread.

Similar to cartridge according to the first aspect of the invention, also the mixing vessel comprises a cup- or bowl-like receptacle having an inner lumen as well as an opening, although typically, the receptacle of the mixing vessel is larger than the cartridge and thus adapted to hold larger volumes; for instance, a volume of an aqueous solvent, or dispersion medium, such as water, into which the pharmaceutical or nutraceutical compositions stored in the cartridge are to be dispensed. Furthermore, the receptacle of the mixing vessel comprises means for receiving the cartridge of the first aspect of the invention. Accordingly, any embodiments, or specific or preferred embodiments, disclosed herein in connection with the cartridge of the present invention, may be applied to the mixing vessel according to this second aspect of the invention. In specific embodiments, the cartridge according to the present invention can be attached to, or inserted in, the cup- or bowl-like receptacle of the mixing vessel having an inner lumen as well as an opening. More specifically, the cartridge may be mounted on the opening of the receptacle, preferably with the help of the mixing vessel's means for receiving the cartridge, so that the opening of the container portion of the cartridge and the opening of the receptacle are facing each other. This may be advantageous to ensure that the contents of the cartridge, i.e. the at least three flowable pharmaceutical or nutraceutical compositions, can be effectively transferred into the receptacle of the mixing vessel once the cartridge is opened.

The mixing vessel's means for receiving the cartridge (i.e. the means to which the cartridge can be attached or into which the cartridge can be inserted) may, for instance, have the form of an elongation of the side wall of the mixing vessel's receptacle, into which the cartridge can be inserted, said elongation extending past the plane of the opening of the mixing vessel. Alternatively, the means for receiving the cartridge can have the form of an annular wall provided on top of the receptacle, into which the cartridge can be inserted, said annular wall concentrically surrounding the opening of the mixing vessel. In preferred embodiments, the internal size and shape of the receiving means (e.g. its inner diameter) corresponds to the shape and size, or diameter, of the circumferential flange of the cover portion of the cartridge, to allow for securely fitting of the cartridge therein and thus matching the two openings of the cartridge and the mixing vessel.

Furthermore, the receptacle and/or the cap of the mixing vessel comprise opening means (hereinafter referred to as ‘opening means of the mixing vessel’) for bringing the cartridge connected to, or received in, the receptacle of the mixing vessel as described above to an opened state by physical interaction with the opening means of the cartridge, more specifically the opening means of the container portion thereof. In specific embodiments, such physical interaction between the opening means of the cartridge's container portion and the opening means of the mixing vessel is effected by connecting the receptacle and the cap of the mixing vessel to each other. More specifically, such physical interaction between the opening means of the cartridge's container portion and the opening means of the mixing vessel is effected by connecting the receptacle and the cap of the mixing vessel to each other; for instance, when closing the mixing vessel with its respective cap, e.g. by screwing on a screw cap. By closing the mixing vessel, due to the physical interaction between the opening means of the cartridge's container portion and the opening means of the mixing vessel, the container portion of the cartridge, or more specifically the segments of the container portion, in these preferred embodiments, are opened into, or towards, the receptacle of the mixing vessel and, accordingly, allow for the dispense of the at least three flowable pharmaceutical or nutraceutical compositions into the receptacle of the mixing vessel. As mentioned above, in one of the preferred embodiments, the cover portion, or respectively the segments thereof (e.g. the flaps), is/are neither cut nor pierced in order for the opening of the container portion to occur; hence, in this embodiment, the opening means of the cartridge's container portion and the opening means of the mixing vessel are free of any cutting means or piercing means. The opening of the container portion preferably occurs as a result of a lever action, or prying effect, acting onto the cover portion when the cartridge physically interacts with the mixing vessel.

In further specific embodiments, the receptacle of the mixing vessel may contain a liquid, preferably an aqueous liquid or, more specifically, a drinkable aqueous liquid to form the basis, or liquid vehicle, for the liquid pharmaceutical or nutraceutical formulation to be prepared with the cartridge according to the (first aspect) of the present invention. Such aqueous liquid may be filled into the receptacle of the mixing vessel prior to use, i.e. prior to connecting the cartridge with, or inserting it into, the receptacle. Depending on the formulation to be prepared, said liquid could, for instance, be tap water. This embodiment is advantageous in terms of, for instance, transport costs, storage stability, etc., over other solutions where all components of a final liquid formulation (i.e. including the aqueous liquid) are stored together in a compartmentilised cartridge. In further embodiments, however, the receptacle may also be prefilled with an aqueous liquid for the preparation of the liquid pharmaceutical or nutraceutical formulation, said formulation preferably comprising at least two active pharmaceutical ingredients and the at least one excipient.

Accordingly, in specific embodiments of the mixing vessel of this aspect of the invention, the receptacle and the cap comprise a liquid-tight closure. Such liquid-tight closure may, for example, be provided in form of a threaded connection (e.g. a screw thread), bayonet- or snap-on connection, as described above, in connection with a sealing ring, such as an elastomeric sealing ring, placed between the receptacle and the cap of the mixing vessel and/or between the receiving means of the receptacle and the cartridge. The mixing vessel usually has a size and shape that allows for convenient use, specifically convenient manual use, by a user or patient to which the pharmaceutical or nutraceutical composition is to be administered. Accordingly, the receptacle of the mixing vessel typically may have an inner volume in the range of from about 20 ml to about 500 ml or from about 50 ml to about 200 ml.

The cap of the corresponding mixing vessel, in advantageous embodiments, has a size and shape that after the closure of the mixing vessel, i.e. after connection of the receptacle with the cap, especially in cases in which the cartridge is mounted on the opening of the receptacle and in the means for receiving the cartridge, allows for the complete enclosure of the cartridge by the cap. Accordingly, in some embodiments, the cap may have a volume typically in the range of from about 10 ml to about 500 ml, often from about 20 ml to about 250 ml. In some embodiments, the cap has a size and shape that allows for the direct contact between the inner surface of the cap and the container base of the cartridge when the cartridge is mounted on the receptacle of the mixing vessel and in the means for receiving the cartridge, and the cap of the mixing vessel is attached to the receptacle.

Corresponding to its inner volume, the receptacle may hold from about 20 ml to about 500 ml, or from about 50 ml to about 200 ml, or from about 75 ml to about 150 ml of the liquid, specifically the drinkable aqueous liquid to form the liquid pharmaceutical or nutraceutical formulation, preferably for oral intake, together with the at least three flowable pharmaceutical or nutraceutical compositions to be dispensed from the cartridge of the present invention upon insertion into, and closure of, the mixing vessel as described above. The at least three flowable pharmaceutical or nutraceutical compositions contained in the cartridge of the present invention may be discharged by the force of gravity into the receptacle of the mixing vessel and thereby come into contact with the liquid already present in the receptacle (either prefilled or filled directly prior to use). Alternatively, the at least three flowable pharmaceutical or nutraceutical compositions can be purged from, or flushed out of, the at least three segments of the container portion of the cartridge by the liquid present in the receptacle, preferably after complete closure of the mixing vessel. In any case, the at least three flowable pharmaceutical or nutraceutical compositions may be dissolved, or suspended, or dispersed in the aqueous drinkable liquid, for example, by shaking the mixing vessel in closed state, with the opened cartridge inside.

The liquid, preferably the aqueous drinkable liquid that may form the basis for the pharmaceutical or nutraceutical formulations to be prepared may be any water-based drinkable liquid, such as water itself, potentially together with other pharmaceutically or nutraceuticals acceptable ingredients or additives, such as sweeteners, sugars, colorants, flavors, buffers, thickeners and the like. The water-based drinkable liquid can, for example, also be a beverage such as a soft drink, milk, or other drinkable liquids, as long as they may not interfere with the pharmaceutical or nutraceutical compositions or, more specifically, the active pharmaceutical ingredients and excipients contained therein.

After mixing or, more specifically after preparing a dissolution, suspension, or dispersion of the at least three flowable pharmaceutical or nutraceutical compositions, to the desired extent, the mixing vessel may be opened, preferably by detaching the cap and removing the opened and emptied cartridge from the receptacle of the mixing vessel, and the pharmaceutical or nutraceutical formulation contained in the receptacle can be administered or consumed, preferably by oral administration.

In a third aspect, the present invention provides a kit comprising the cartridge according to the first aspect of the invention and a matching mixing vessel according to the second aspect of the invention for preparing a liquid pharmaceutical or nutraceutical formulation, preferably a liquid pharmaceutical or nutraceutical formulation comprising the at least two active pharmaceutical ingredients and the at least one excipient. Optionally, the kit comprises a plurality of the cartridge according to the first aspect of the invention and a matching mixing vessel according to the second aspect of the invention; in other words, the mixing vessel may be intented for multiple use.

All embodiments, including all specific or preferred embodiments, as described above in connection with the cartridge of the first aspect of the invention as well as in connection with the mixing vessel of the second aspect of the invention also apply to the kit according to this third aspect of the invention.

Accordingly, the kit of this third aspect of the invention comprises a cartridge with at least three segments and comprising at least three flowable pharmaceutical or nutraceutical compositions as described in detail above. As also described in detail above, the at least three flowable pharmaceutical or nutraceutical compositions provided in the segments of the cartridge comprise, in preferred embodiments, at least two active pharmaceutical ingredients and at least one excipient. Furthermore, the mixing vessel comprised by the kit of this aspect of the invention comprises a receptacle and a cap, wherein the receptacle may, or may not, be prefilled with the liquid, preferably an aqueous drinkable liquid.

In a fourth aspect, the present invention provides a method for preparing a liquid pharmaceutical or nutraceutical formulation, preferably a liquid pharmaceutical or nutraceutical formulation comprising at least two active pharmaceutical ingredients and at least one excipient, the method comprising the steps of:
a) providing a cartridge according to the first aspect of the invention;
b) providing a mixing vessel according to the second aspect of the invention;
c) optionally filling the receptacle of the mixing vessel with an aqueous liquid;
d) connecting the cartridge and the receptacle of the mixing vessel, preferably attaching or inserting the cartridge onto or into the receptacle of the mixing vessel;
e) connecting the receptacle with the cap of the mixing vessel,
f) bringing the cartridge in an opened state, specifically by closing the receptacle by the cap of the mixing vessel.

According to step a) of the method of this fourth aspect of the invention the cartridge according to the first aspect of the invention is provided. With regard to that cartridge, all embodiments, including preferred and specific embodiments and all combinations thereof as described above in connection with the first aspect of the invention, apply accordingly.

According to step b), a mixing vessel as described above according to the second aspect of the invention is provided. With regard to the mixing vessel also, all embodiments, including preferred and specific embodiments and all combinations thereof as described above in connection with the second aspect of the invention, apply. Accordingly, the mixing vessel also comprises a receptacle and cap which may be connected to each other as described above.

According to optional step c), the receptacle of the mixing vessel may be filled with an aqueous liquid prior to connecting the cartridge with, or inserting it into, the receptacle of the mixing vessel. In alternative embodiments, the mixing vessel, or more specifically the receptacle of the mixing vessel, is provided in prefilled form in which the aqueous liquid is already filled in the receptacle prior to use; for instance, at the production site.

In step d) of the method of this aspect of the invention, the cartridge and the receptacle of the mixing vessel are connected, preferably by attaching or inserting the cartridge onto or into the mixing vessel.

According to step e), the receptacle of the mixing vessel is connected with the cap of the mixing vessel. In specific embodiments, the cap may, for example, be screwed on, or otherwise get connected with the receptacle of the mixing vessel. It should be noted that, according to step e), the term ‘connected with’ does not mean that the cap and the receptacle of the mixing vessel have to be firmly attached to each other. In specific cases in which the two components are attached by a thread, for example, the cap may be screwed on the receptacle up to an intermediate position.

According to step f), finally, the cartridge is brought in an opened state, as affected by the physical interaction between the opening means of the cartridge's container portion and the opening means of the mixing vessel as described above. In specific embodiments, steps e) and f) may be performed simultaneously while connecting the cap of the mixing vessel with the receptacle, for example, during screwing, or otherwise attaching, the (screw) cap of the mixing vessel to the receptacle.

In further specific embodiments, the method according to this fourth aspect of the invention may further comprise step g) in which the cartridge is detached from the receptacle of the mixing vessel. Furthermore, the method may comprise an additional step h) in which the cartridge is removed from the receptacle. According to this additional step h) the emptied, or almost emptied, cartridge is removed or detached from the receptacle of the mixing vessel, after dispensing the at least three flowable pharmaceutical or nutraceutical compositions, thereby opening the receptacle so that the pharmaceutical or nutraceutical formulation can be administered or consumed.

In a fifth aspect, the present invention also refers to a liquid pharmaceutical or nutraceutical formulation, preferably a liquid pharmaceutical or nutraceutical formulation comprising at least two active pharmaceutical ingredients and at least one excipient, obtained or obtainable by the method according to the fourth aspect of the invention.

In a sixth aspect, the present invention provides a method for the manufacture of a cartridge according to the first aspect of the invention, the method comprising the steps of:
a₁) providing the container portion of the cartridge according to the first aspect of the invention;
b₁) selectively filling the at least three segments of the inner lumen of the container portion with the at least three flowable pharmaceutical or nutraceutical compositions, specifically comprising at least two active pharmaceutical ingredients and at least one excipient; and
c₁) closing the filled container portion of the cartridge with the cover portion.

According to step a₁) of the manufacturing method of this sixth aspect of the invention, the container portion of the cartridge as described in detail above in connection with the first aspect of the invention is provided. In this aspect also, all embodiments, including specific and preferred embodiments and combinations thereof as described above in connection with the other aspects of the invention, apply to this sixth aspect also. Accordingly, the container portion of the cartridge comprises a segmenting structure and at least three segments that may be filled with the at least three flowable pharmaceutical or nutraceutical compositions to be administered. The container portion may, in preferred embodiments, be manufactured by injection molding as described above, specifically by injection molding of a thermoplastic material. In this particular case, the dividing walls of the segmenting structure preferably are oriented parallel to the main central axis of the container portion of the cartridge.

The manufacturing method of this sixth aspect of the invention may further comprise as a step a₂) the coating of the inner surface of the container portion and the surfaces of the segmenting structure (or at least those to be exposed to the at least three flowable pharmaceutical or nutraceutical compositions) and/or the inner surface of the cover portion with a non-stick coating as described above in connection with the first aspect of the invention. The optional step a₂) may be advantageously performed prior to the filling of the at least three segments of the container portion according to step b₁) of the present method.

According to step c₁) of this sixth aspect of the invention, the filled container portion of the cartridge is closed with the cover portion. The method may also comprise, as a further optional step c₀) the coating of the inner surface of the cover portion (i.e. the surface facing the inner lumen of the container portion), or the segments of the container portion, respectively (i.e. the surface to be exposed to the at least three flowable pharmaceutical or nutraceutical compositions) with a non-stick coating as described above in connection with the first aspect of the invention. For practical reasons, such coating may be applied prior to the closing of the cartridge with the cover portion according to step c₁).

In a further specific embodiment, the manufacturing method may comprise as an optional step a₃) the sterilizing of the container portion. Such sterilizing of the container portion may advantageously be conducted before filling of the container portion, or the segments of the container portion, with the at least three flowable pharmaceutical or nutraceutical compositions.

The invention is exemplarily described by aid of the following Figures:

### DETAILED DESCRIPTION OF THE DRAWINGS

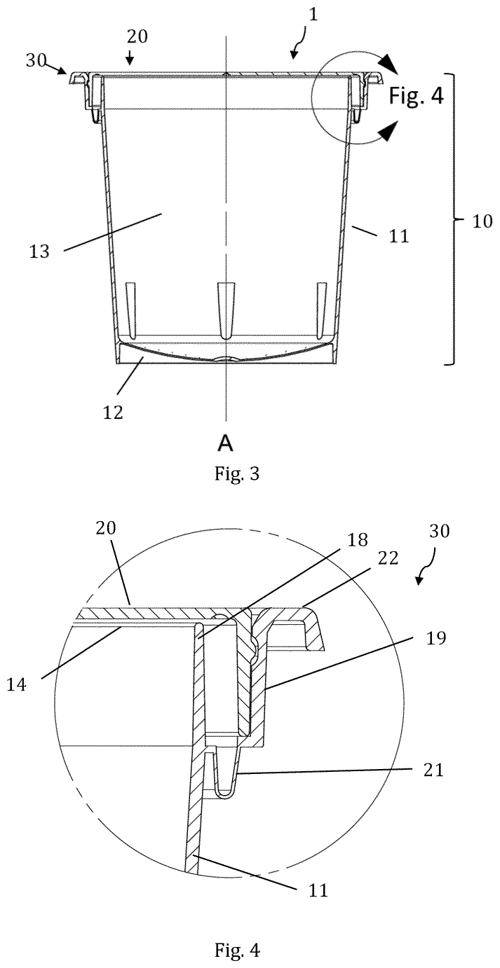

FIG. 1a shows a three-dimensional perspective view of a cartridge 1 of the present invention with six segments 16 and the cover portion removed. The container portion 10 of the cartridge 1 has a cup- or bowl-like conical shape, and comprises a container wall 11 and a circular container base 12, as well as a segmenting structure 15 dividing the entire inner lumen 13 of the container portion 10 into six segments 16. In this particular embodiment, the six segments 16 have an equal size and shape. The segmenting structure comprises six dividing walls 17 contacting each other at the common main central axis A (see axis in FIG. 3). The cartridge 1 depicted in FIG. 1a also has opening means 30, more specifically the opening means of the container portion thereof, which in this case is located at the upper end of the container wall 11 and is surrounding the opening 14 of the container portion 10. In the preferred embodiment, shown in FIG. 1a, the opening means (30) of the container portion (10) is free of any cutting means or piercing means.

FIG. 1b shows a three-dimensional perspective view of a cover portion 20 corresponding to the container portion 10 of cartridge 1 as depicted in FIG. 1a. The particular cover portion as shown in FIG. 1b comprises two flaps 23 of equal size and shape, namely in form of regular segments of a circle (here the diameter segment, i.e. two semicircles). The cover portion of FIG. 1b is shown from the top side so that the inner surface (not shown) of the cover portion 20 is facing downwards. On the upper surface of the cover portion 20, a trench 24 is visible, dividing the cover portion 20 into the two flaps 23. Furthermore, the cover portion has radially outward facing protrusions 29 on its outer perimeter for placement of the cover portion in correct orientation of the sealing means (as described below) towards the segmenting structure.

FIG. 1c shows a three-dimensional perspective view of a cover portion 20 corresponding to the container portion 10 of cartridge 1 as depicted in FIG. 1a. The particular cover portion as shown in FIG. 1c also corresponds to the one of FIG. 1b and comprises two flaps 23 of equal size and shape, namely in form of regular segments of a circle (two semicircles). The cover portion of FIG. 1c is shown from the bottom side so that the inner surface 25 of the cover portion is facing upwards. As described in detail above, the inner surface 25 of the cover portion (as well as the surfaces of the dividing walls and the inner surface of the container base 12) may, or may not, be coated with a non-stick coating. The cover portion of FIG. 1c further shows sealing lips 28 corresponding to the upper free edges of the container wall and the segmenting structure's dividing walls. Accordingly, the cover portion 10 of FIG. 1c corresponds to, and is suitable to close, the container portion 10 as shown in FIG. 1a. In this case, the sealing lips 28 allow for the tight closure, especially the liquid-tight closure of the individual segments 16 of container portion 10 as shown in FIG. 1a. As can be seen from the exemplary embodiments depicted in FIGS. 1a, 1b and 1c, it is possible that the number, size and shape of the flaps 23 of the cover portion 20 (here two semicircles) do not correspond to the number, size and shape of the openings of the individual segments 16 (here six equally sized circular sectors). Of course, this applies to different sealing options, too. For example, it is possible that the cover portion 20 comprises two flaps 23, e.g. in the form of a semicircle, as it is the case in this FIG. 1b, and the container portion comprises a plurality of at least three segments 16, such as three to eight, or three to six, or three to four, segments 16. As long as the sealing means provided on the inner surface of the cover portion 20, e.g. sealing lips 28, correspond to the openings of the container portion's individual segments 16 in terms of number, size and shape, a liquid-tight closure can be achieved independent of the number, size and shape of the cover portion's flaps.

The cover portion 20 may be provided with one or more radially outward facing protrusions 29 on its outer perimeter for placement of the cover portion in correct orientation of the sealing means towards the segmenting structure. Accordingly, the container portion 10 is provided with corresponding indentations.

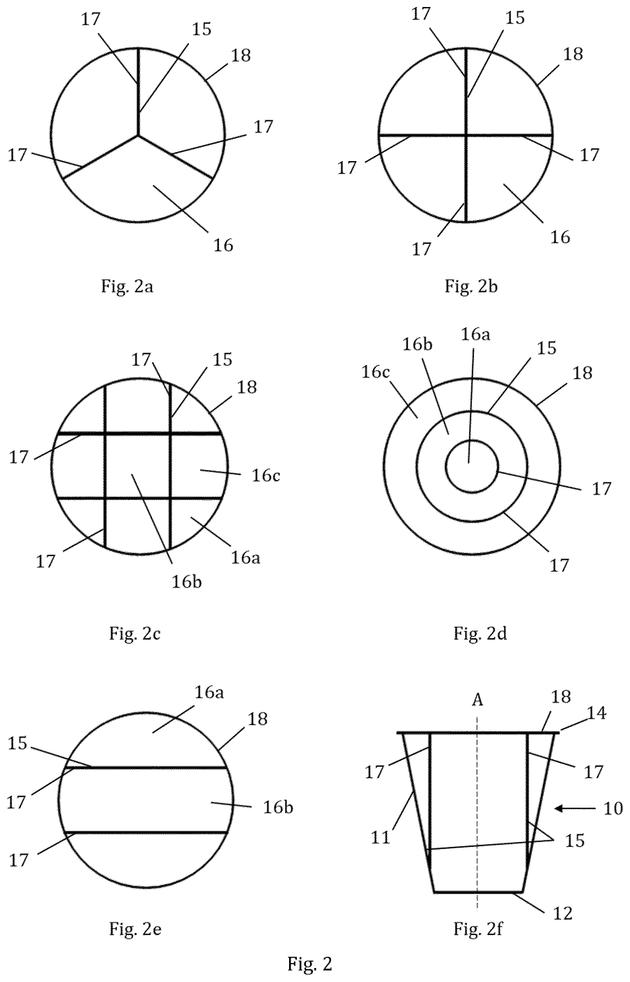

The segmenting structure 15 may have different shapes and geometries, depending on the number and individual size of segments 16 that are to be provided per cartridge 1. Accordingly, FIGS. 2a to 2f show two-dimensional schematic representations of exemplary segmenting structures 15 of the cartridge 1 of the present invention. More specifically, FIGS. 2a to 2e show schematic representations of the container portion 1 and the segmenting structure 15 as seen from the top of the container portion 10 along the central main axis A (not shown in FIGS. 2a to 2e, see FIG. 2f) of the container portion 10, through the opening 14 of the container portion 10, and into the inner lumen of the segments 16 of the container portion 10. In other words, FIGS. 2a to 2e show the upper edge of the container wall 18, as well as the upper edges of the segmenting structure 15.

FIG. 2a shows a specific embodiment wherein the segmenting structure 15 comprises three dividing walls 17 dividing the entire inner lumen 13 of the container portion 10 into three segments 16 of equal size and shape. In this particular case, neighboring dividing walls 17 enclose an angle of 120°.

FIG. 2b shows a further specific embodiment in which the segmenting structure 15 comprises four dividing walls 17 dividing the inner lumen 13 of the container portion 10 into four segments 16 of equal size and shape. In this particular case, neighboring dividing walls 17 enclose a right angle.

FIG. 2c shows another possible embodiment in which the segmenting structure 15 is provided in form of a grid of dividing walls 17, intersecting each other at right angles. In this case, however, at least two of the dividing walls 17 run parallel to each other. Furthermore, in this particular embodiment, segments 16 are provided with three different shapes and sizes, namely segments 16a, 16b and 16 c.

FIG. 2d shows yet another specific embodiment of the cartridge of the present invention in which the segmenting structure 15 is provided in the form of concentric dividing walls 17 with regard to the central main axis A (not shown). In this case also, three segments 16a, 16b and 16c with different shapes and volumes are provided. It should be noted that, in this particular embodiment, the dividing walls 17 may be attached to the container base 12 only, and, accordingly, may not contact the container wall 11 of the container portion 10.

FIG. 2e shows another specific embodiment of the container portion 10 of the present invention in which the segmenting structure 15 is provided in the form of two parallel dividing walls 17 which, accordingly, have no contact to each other. In this embodiment also, three segments 16 are provided with different sizes and shapes, namely in the form of the outer segments 16a and the inner segment 16b. It should be understood, however, that the position of the dividing walls 17 can be chosen according to the required shapes and volumes of the resulting segmenting structures 17. For example, segmenting walls 17 can be provided in a non-symmetrical fashion so that three different segments 16 result. Furthermore, the dividing walls 17 may be connected to the container base 12 and to the surrounding container wall 11, as shown in FIG. 2e.

FIG. 2f shows a two-dimensional, cross-sectional side view of another possible embodiment similar to the embodiment as shown in FIG. 2e. In this case, however, the dividing walls 17, running parallel to each other and parallel to the central main axis A, are attached to the container wall 11 of the container portion 10 only. In this embodiment, however, the container base 12 has a smaller diameter than the container opening and, accordingly, the container portion 10 has a cone-shaped or tapered form.

In all the embodiments as shown in FIG. 2 and described above, it may be advantageous that the dividing walls 17 of the segmenting structure 15 are oriented parallel to the main axis A of the container portion 10. This may be beneficial especially in cases in which the container portions comprising the segmenting structure are to be manufactured by injection molding, preferably in the form of a single piece. Furthermore, in general, it is also preferred that the container base 12 has a smaller diameter than the container opening and, accordingly, the container portion 10 has a cone-shaped or tapered form. Furthermore, it should be noted that the container portion 10, or, more specifically the container wall 11 may have a circular cross section area as depicted in FIGS. 2a to 2e. However, it is also possible that the container wall and/or the opening 14 of the container portion has an irregular, oval or polygonal cross-sectional area.

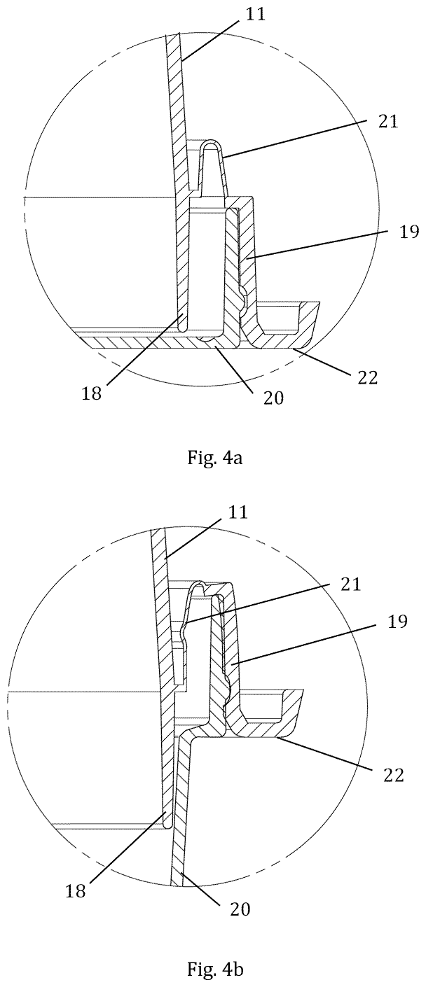

FIG. 3 shows a two-dimensional, cross-sectional side view of the cartridge 1 of FIG. 1a with the segmenting structure omitted for clarity. The container portion 10 of the cartridge 1, in this exemplary embodiment, has a conical shape with container wall 11 and container base 12 enclosing inner lumen 13 of the container portion 10. FIG. 3 also shows the cover portion 20 as well as the opening means 30 of the container portion. Opening means 30 are to be described in further detail below on the basis of an enlarged cross-sectional view of FIG. 4.

FIG. 4 shows an enlarged cross-sectional view of the opening means 30 of the container portion. According to this exemplary embodiment, the container wall 11 of cartridge 1 comprises an edge 18, or upper edge 18, surrounding the opening 14 of the container portion, and an upper skirt 19 with a circumferential flange 22 also surrounding the opening 14 of the container portion 10, wherein the upper skirt 19 is radially and outwardly spaced from the edge 18 of the container wall 11, and wherein the cover portion 20 is connected to, or held in contact with, the upper skirt 19 surrounding the opening 14 of the container portion 10. The upper skirt 19 is attached to, of affixed to, the container wall 11 by a hinging connector section 21. In this exemplary embodiment, the hinging connector section 21 allows for the displacement of the upper skirt 19 of the container portion 10 relative to the upper edge 18 of the container wall 11 to bring the cartridge 1, or capsule, from a closed state to an opened state.

FIG. 4a which is identical to the enlarged view of FIG. 4 turned upside down shows the opening means 30 of the container portion 10 of FIG. 4 in the closed state.

FIG. 4b shows the same enlarged view of the opening means 30 of the container portion 10 of FIG. 4 in the opened state.

As mentioned above, the opening means 30 of the cartridge's container portion 10 depicted in FIGS. 4, 4a and 4b is free of any cutting means or piercing means. The opening of the container portion 10 preferably occurs as a result of a lever action, or prying effect, acting onto the cover portion 20 when the cartridge 1 physically interacts with the mixing vessel 100; or, in other words, the cover portion, or respectively the segments thereof (e.g. the flaps), is/are neither cut nor pierced by the opening means 30 in order for the opening of the container portion 10 to occur.

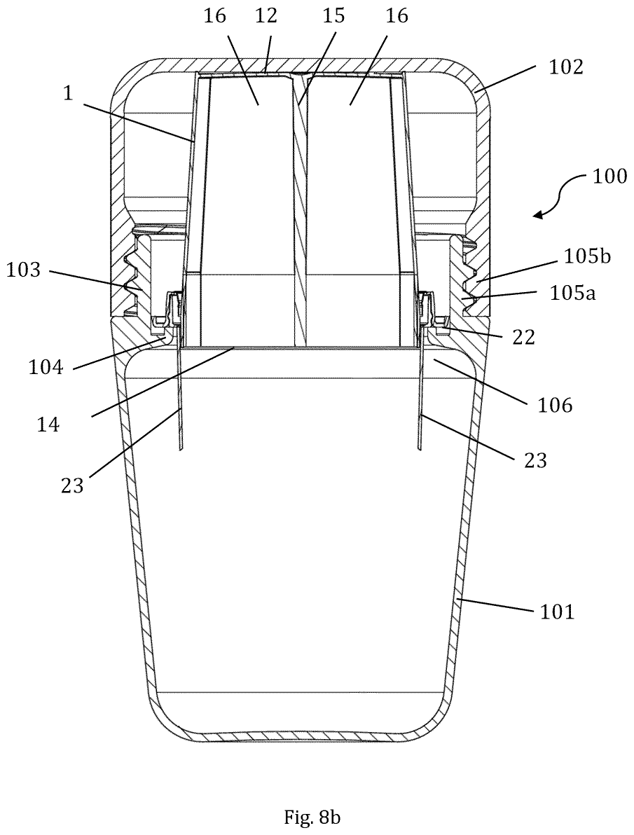

As further shown in FIG. 4a, the hinging connector portion 21 (or hinging connector section 21), in the closed state in a cross-sectional view can have a substantially loop-shaped or U-shaped form. In these case, by a displacement or shift of the upper skirt 19 and circumferential flange 22 in direction of the container base (not shown), the flaps 23 of the cover portion 20 open (e.g. due to physical contact with a (stationary) opening means 104 of the mixing vessel 100 as described in further detail below for FIG. 8b), and the hinging connector portion 21 preferably is stretched or straightened as shown in FIG. 4b. Due to said stretching or straightening of the substantially loop- or U-shaped part of the hinging connector portion 21, or hinging connector section 21, it can also exert a restoring force that may facilitate a back-shift of the upper skirt 19 of the container portion into the closed state. This ‘re-closure’ of the cover portion's segments (e.g. the flaps 23) can be advantageous for a cleaner removal of the cartridge 1 from the mixing vessel 100 after the cartridge was opened and its contents dispensed, since the opened flaps typically get wetted with the contents of the mixing vessel during mixing process. The maximum shift may approximately correspond to the length of the hinging connector section 21, i.e. approximately double the length of a wing of the loop- or U-shaped hinging connector section 21.

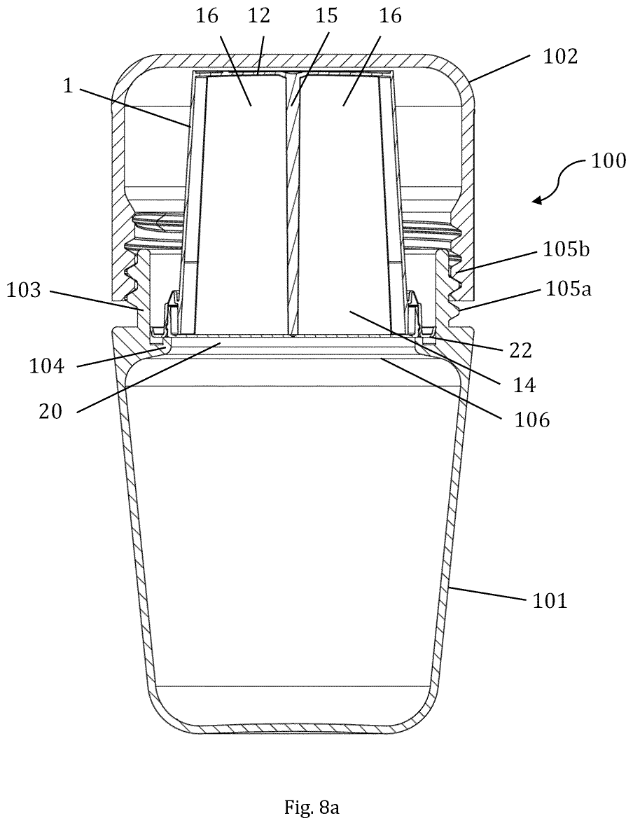

In the embodiment shown in FIG. 4, the upper skirt 19 of the container portion 10 has the form of a further wall which may be positioned essentially parallel to the container wall 11. The lower end of said further wall (in FIGS. 4a and 4b facing upwards due to said figures being turned upside down) may be connected to the hinging connector portion 21 (or hinging connector section 21). At the upper skirt 19 of the container portion 10, or at the upper end of that further wall (in FIGS. 4a and 4b facing downwards), respectively, a circumferential flange 22 is provided which is oriented outwardly, i.e. away from the container wall 11 and/or the upper skirt 19 in form of the further wall. In this specific embodiment, the circumferential flange 22 allows for the physical interaction with the opening means of the mixing vessel (not shown in FIG. 4, see FIG. 7).

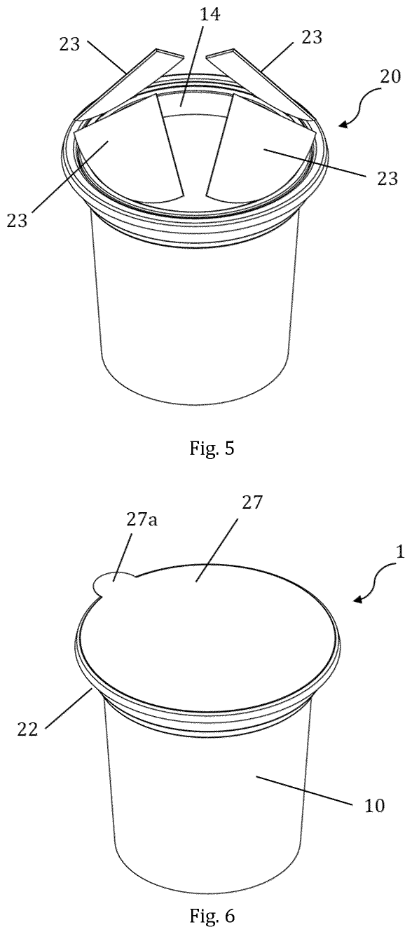

FIG. 5 shows a perspective top-view of a cartridge of the present invention with the cover portion 20 in an opened state (segmenting structure omitted for clarity). In the shown embodiment, the cover portion 20 comprises four flaps 23 of equal size and shape. In the embodiment as depicted in FIG. 5, the cover portion 20, or more specifically the flaps 23 of the cover portion 20, are not completely in the opened state, in which each of the flaps 23 are displaced ideally to the maximum possible, i.e. to enclose a right angle with regard to the opening 14 of the container portion to allow for an unhindered dispense of the at least three pharmaceutical or nutraceutical compositions contained in the segments (not shown in FIG. 5) of the container portion.

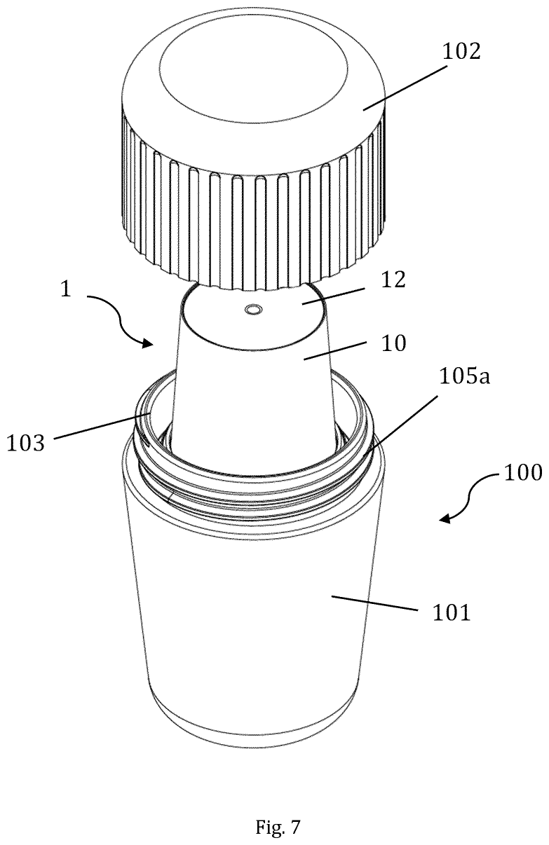

FIG. 6 shows another embodiment of the cartridge 1 of the present invention with container portion 10 and circumferential flange 22 of the opening means of the container portion surrounding its opening. In the shown embodiment, the cover portion (not visible) is covered, or sealed, by a sealing foil 27. The sealing foil 27 may be attached to the outer surface of the cover portion (not visible) or to the outer surface of the flaps of the cover portion, if present or to the circumferential flange 22, to seal the entire upper surface of the container. The sealing foil 27 may be removed, or detached, from the outer surface of the cover portion by pulling the grip 27a provided in form of an extra portion of the sealing foil extending beyond the boundaries of the cover portion. The sealing foil 27 ensures that the outer surface of the cover portion, or the flaps of the cover portion, respectively, cannot be contaminated before the actual use or introduction of the cartridge 1 into the mixing vessel 100 (see FIG. 7) where, upon opening of the cartridge, the pharmaceutical or nutraceutical formulation to be prepared may get into contact with the outer surface of the cover portion, and, accordingly, might become contaminated as well.

FIG. 7 shows a perspective view of the mixing vessel 100 with receptacle 101 and cap 102 detached from each other and the cartridge 1 of the present invention mounted on the mixing vessel's receptacle 101. Specifically, the cartridge is mounted on, or rather in, the means 103 for receiving the cartridge of the receptacle 101 in an upside-down orientation so that the opening of the container portion (not visible) is oriented towards the opening of the receptacle 101 of the mixing vessel 100, and the container base 12 is oriented upwards in the direction of the cap 102 of the mixing vessel 100.

FIGS. 8a and 8b show cross-sectional views of the mixing vessel 100 with the cartridge 1 inserted.

In FIG. 8a, the mixing vessel 100 is shown in a assembled state with receptacle 101 and cap 102 connected to each other, and the cartridge 1 of the present invention mounted on the receptacle 101 and in the means 103 for receiving the cartridge, so that the opening 14 of the container portion (still covered by the cover portion 20 in a closed state) faces the opening 106 of the receptacle. Receptacle 101 of the mixing vessel 100 comprises means 103 for receiving cartridge 1. In the shown embodiment, the means 103 for receiving the cartridge has the form of an elongation of the side wall of the receptacle 101 with a constant inner diameter, preferably, with a shape or diameter that corresponds to the shape and diameter of the circumferential flange 22 of the cover portion of the cartridge 1. In the embodiments shown in FIG. 8a, the peripheral frame of the cover portion of the cartridge 1 abuts, or contacts, the opening means 104 of the mixing vessel 100. As shown in FIG. 8a, the opening means 104 of the mixing vessel 100 is free of any cutting means or piercing means. Receptacle 101 has an outer thread 105a onto which cap 102 having a corresponding inner thread 105b of the cap is screwed. It should be noted that in the shown state, while cap 102 is not completely screwed onto receptacle 101, the inner surface of the cap 102 abuts the container base 12 of the inserted cartridge 1. In this situation, cartridge 1 with the segmenting structure 15 (just one dividing wall shown in cross-section) and resulting segments 16 for holding the at least three flowable pharmaceutical or nutraceutical compositions is still in a closed state.

FIG. 8b shows the situation as shown in previous FIG. 8a after complete closure of the mixing vessel 100. In this situation depicted in FIG. 8b, namely, the mixing vessel 100 with receptacle 101 and cap 102 tightly connected to each other, the cartridge 1 of the present invention mounted on the receptacle 101 is in an opened state. Flaps 23 of the cover portion are in an opened position so that all segments 16 of the inner lumen of the container portion are open to the inner lumen of the receptacle. Accordingly, the at least three flowable pharmaceutical or nutraceutical compositions initially contained in the at least three segments 16 of the container portion may be dispensed into receptacle 101, for example by the mere force of gravity or supported by shaking or tapping on the mixing vessel. Furthermore, in cases in which the receptacle 101 holds an aqueous liquid, preferably a drinkable aqueous liquid as described in further detail above, the at least three flowable pharmaceutical or nutraceutical compositions may be purged or flushed from the segments 16, for example, by shaking the tightly closed mixing vessel 100. In these cases, as already described above, it may be beneficial to have an additional liquid-tight closure or seal between receptacle 101 or, more specifically between receiving means 103 of the receptacle and cartridge 1.

As can be seen from FIG. 8b, upon complete closure of the threaded connection between receptacle 101 and cap 102, in this particular embodiment driven by contact between the container base 12 of cartridge 1 and the inner surface of cap 102, the cartridge is pushed towards the inner lumen of receptacle 101. Thereby, circumferential flange 22 of the opening means of the container portion is pushed in the opposite direction (towards container base 12) due to the physical contact of the opening means 104 of the mixing vessel, here a stationary opening means 104. In other words, the opening of the container portion 10 occurs as a result of a lever action, or prying effect, acting onto the cover portion 20 when the cartridge 1 physically interacts with the mixing vessel 100; the cover portion 20, or respectively the segments thereof (e.g. the flaps 23), is/are neither cut nor pierced in order for the opening of the container portion 10 to occur.

### LIST OF REFERENCES

1 cartridge
100 mixing vessel
10 container portion
20 cover portion
30 opening means (of the container portion)
11 container wall
12 container base
13 inner lumen (of the container portion)
14 opening (of the container portion)
15 segmenting structure
16 segments (of the inner lumen of the container portion)
17 dividing walls
18 edge of the container wall
19 upper skirt
21 hinging connector section, or hinging connector portion
22 circumferential flange
23 flaps (of the cover portion)
24 trench (in the cover portion)
25 inner surface of the cover portion
26 outer surface of the cover portion
27 sealing foil
27a grip of the sealing foil
28 sealing lips
29 protrusion
101 receptacle of the mixing vessel
102 cap of the mixing vessel
103 means for receiving the cartridge
104 opening means (of the mixing vessel)
105a thread of the receptacle
105b inner thread of the cap
106 opening of the receptacle
A central main (rotational) axis

The following list of numbered items are embodiments comprised by the present invention:
1. A cartridge for the preparation of a liquid pharmaceutical or nutraceutical formulation, the cartridge being adapted for insertion into a mixing vessel and for dispensing at least three flowable pharmaceutical or nutraceutical compositions into said mixing vessel, the cartridge comprising a container portion, a cover portion and an opening means, or more specifically an opening means of the container portion, for opening the cartridge, preferably after its insertion into the mixing vessel, wherein
   the container portion comprises
   a) a container wall and a container base, the container wall and the container base defining an inner lumen and an opening of the container portion, the opening being positioned opposite to the container base, and
   b) a segmenting structure located in the inner lumen of the container portion and being physically connected to the container wall and/or to the container base such as to divide the inner lumen of the container portion into at least three segments containing the at least three flowable pharmaceutical or nutraceutical compositions; and
   wherein
   the cover portion is attached to the container portion and, in a closed state, contacts the container wall and the segmenting structure, thereby closing the at least three segments of the inner lumen of the container portion; and wherein
   the opening means, or more specifically an opening means of the container portion, is adapted to partially remove the cover portion from the container wall and/or the segmenting structure, thereby opening the at least three segments of the inner lumen of the container portion to dispense the flowable pharmaceutical or nutraceutical compositions contained therein into the mixing vessel.
2. The cartridge according to item 1, wherein each of the at least three segments contains one of the at least three flowable pharmaceutical or nutraceutical compositions.
3. The cartridge according to item 1 or 2, wherein each of said at least three flowable pharmaceutical or nutraceutical compositions is different from the other compositions present in the cartridge.
4. The cartridge according to any of the preceding items, wherein the at least three flowable pharmaceutical or nutraceutical compositions combined comprise at least two active pharmaceutical ingredients.
5. The cartridge according to any of the preceding items, wherein the at least three flowable pharmaceutical or nutraceutical compositions combined comprise at least one excipient.
6. The cartridge according to any of the preceding items, wherein the at least three flowable pharmaceutical or nutraceutical compositions combined comprise at least two active pharmaceutical ingredients and at least one excipient.
7. The cartridge according to any of items 4 to 6, wherein each of the at least two active pharmaceutical ingredients is present in, or comprised by, only one of the at least three flowable pharmaceutical or nutraceutical compositions.
8. The cartridge according to any of the preceding items, wherein the cartridge is adapted to dispense three, four, five or six flowable pharmaceutical or nutraceutical compositions into the mixing vessel.
9. The cartridge according to any of the preceding items, wherein the segmenting structure divides the inner lumen of the container portion into three, four, five, or six segments.
10. The cartridge according to any of the preceding items, wherein one of the segments contains a flowable pharmaceutical or nutraceutical composition that does not comprise an active pharmaceutical ingredient, and wherein each of the other segments contain a pharmaceutical or nutraceutical composition comprising an active pharmaceutical ingredient.
11. The cartridge according to any of the preceding items, wherein the container portion comprises three segments, and wherein two of the segments contain a flowable pharmaceutical or nutraceutical composition comprising an active pharmaceutical ingredient, and wherein one of the segments comprise a pharmaceutical or nutraceutical composition that does not comprise an active pharmaceutical ingredient.
12. The cartridge according to any preceding item, wherein one or more of the flowable pharmaceutical or nutraceutical compositions are provided in form of a powder, granules, pellets or in form of a liquid.
13. The cartridge according to item 12, wherein all of the flowable pharmaceutical or nutraceutical compositions are provided in form of powder, pellets, granules, or other particulate materials.
14. The cartridge according to any of the preceding items, wherein the at least three flowable pharmaceutical or nutraceutical compositions combined comprise at least two active pharmaceutical ingredients; and wherein two or more, optionally all, of the at least two active pharmaceutical ingredients are selected from beta-blockers, angiotensin-converting enzyme (ACE) inhibitors, diuretics, calcium channel blockers, oral antidiabetic drugs, HMG-CoA reductase inhibitors (Statins), angiotensin receptor blockers, proton pump inhibitors, antiplatelet drugs, anticoagulant drugs, alpha-blockers, antidepressants, antiemetics, anticonvulsants, anti-inflammatory drugs, anxiolytic drugs, dopamine receptor agonists, neuroleptics, antidementia drugs, analgesics, mucoactive agents, antiparkinson drugs, sympathomimetic drugs, and xanthine oxidase inhibitors.
15. The cartridge according to any of the preceding items, wherein the at least three flowable pharmaceutical or nutraceutical compositions, preferably the pharmaceutical or nutraceutical composition that does not comprise an active ingredient, comprises at least one excipient selected from thickeners, wetting agents, antifoaming agents, binders and diluents.
16. The cartridge according to item 15, wherein the thickener is selected from xanthan gum, carrageenan, tragacanth gum, gum guar, alginates, agar-agar, modified starch, carboxymethylcellulose, crystalline cellulose alone or in combination with other hydrocolloids (AVICEL® RC-591 or AVICEL® CL-611 of FMC Corporation).
17. The cartridge according to item 15, wherein the wetting agent is selected from dioctyl sodium sulphosuccinate, sodium laurylsulphate, sorbitol, and sorbitane esters with fatty acids.
18. The cartridge according to item 15, wherein the antifoaming agent is selected from insoluble oils like medium chain triglycerides (MCTs), polydimethylsiloxanes and other silicones, alcohols, stearates and glycols for the preparation of an attractive solution, dispersion, or suspension of the chosen active pharmaceutical ingredient(s) in water, or other aqueous, drinkable liquid, without foam formation.
19. The cartridge according to item 15, wherein the binder is selected from the group of water-soluble compounds like polyethylene glycols, polyvinyl alcohols, polyvinylpyrrolidone, and cellulose ethers such as methyl cellulose, hydroxypropylmethyl cellulose, hydroxyethyl cellulose, hydroxypropyl cellulose.
20. The cartridge according to item 15, wherein the inert diluent is selected from sucrose, lactose, levulose, mannitol, sorbitol, isomaltitol, maltodextrins, and microcrystalline cellulose.
21. The cartridge according to any of items 15 to 20, wherein the thickener (thickening agent) and/or binder may cause thixotropic properties of the resulting liquid pharmaceutical or nutraceutical formulation upon mixing with water or an aqueous vehicle.
22. The cartridge according to any preceding item, wherein the segmenting structure is provided in form of dividing walls oriented perpendicular to the container base and the perpendicular to the plane of the opening of the container portion.
23. The cartridge according to any one of the preceding items, wherein the at least three segments, specifically the three to six segments, more specifically the three or four segments or the three segments have an equal (shape and) volume.
24. The cartridge according to any one of the preceding items, wherein the segmenting structure is provided in form of at least three dividing walls with a common symmetry axis which is oriented perpendicular to the container base and the plane of the opening of the container portion.
25. The cartridge according to any preceding item, wherein the segmenting structure is located in the inner lumen of the container portion and is physically connected to the container wall and/or to the container base such as to divide the entire inner lumen of the container portion into at least three segments containing the at least three flowable pharmaceutical or nutraceutical compositions.
26. The cartridge according to any one of the preceding items, wherein the container wall comprises an edge surrounding the opening of the container portion and an upper skirt surrounding the opening of the container portion, wherein the upper skirt is radially and outwardly spaced from the edge of the container wall, and wherein the cover portion is connected to, or held in contact with, the upper skirt surrounding the opening of the container portion, and wherein the upper skirt is attached to, or affixed to, the container wall by a hinging connector section.
27. The cartridge according to item 26, wherein the hinging connector section allows for the displacement of the upper skirt of the container portion relative to the upper edge of the container wall and to the opening means of the container portion to bring the cartridge, or capsule, from a closed state to an opened state.
28. The cartridge according to item 27 wherein the opening means of the container portion are located below the cover portion in the closed state and are displaced outwardly in relation to the cover portion in the opened state to open the cover portion.
29. The cartridge according to any of the preceding items, wherein the cover portion comprises a peripheral frame and at least two flaps, specifically two to six flaps, or three to four flaps attached to the frame, wherein each flap is attached to the frame by (at least one) separate hinge.
30. The cartridge according to item 29 wherein the at least two flaps are generated by at least one trench in the cover portion.
31. The cartridge according to item 29 or 30, wherein the at least two flaps have an equal size and shape.
32. The cartridge according to any one of items 29 to 31, wherein the number of flaps equals the number of segments of the container portion.
33. The cartridge according to any of the preceding items, wherein the cover portion has an inner surface facing the inner lumen of the container portion and an outer surface facing the outside of the cartridge, or capsule, wherein the cover portion comprises, or is covered by, a detachable sealing foil attached to the outer surface of the cover portion and/or to the circumferential flange of the container portion.
34. The cartridge according to any of the preceding items, wherein the cover portion comprises additional sealing means sealing the connection between the cover portion and the dividing walls of the segmenting structure.
35. The cartridge according to any one of the preceding items, wherein the container portion comprising the container wall, the container base and the segmenting structure are formed as a single piece, optionally by injection molding.
36. The cartridge according to any one of the preceding items, wherein the container wall, the container base and/or the segmenting structure of the container portion is formed from a thermoplastic material.
37. The cartridge according to any one of the preceding items, wherein the inner surface of the container portion and the surfaces of the segmenting structure (exposed to the at least three flowable pharmaceutical or nutraceutical compositions) are coated with a non-stick coating.
38. A mixing vessel for the preparation of a liquid pharmaceutical or nutraceutical formulation, preferably comprising at least two active pharmaceutical ingredients and at least one excipient, wherein the mixing vessel comprises a receptacle and a cap, wherein the receptacle and the cap can be releasably connected with each other, and wherein the receptacle comprises means for receiving the cartridge of any one of items 1 to 37, and wherein the receptacle and/or the cap comprise opening means (of the mixing vessel) for bringing the cartridge received in the receptacle to an opened state by physical interaction with the opening means of the cartridge, or more specifically with the opening means of the container portion thereof.
39. The mixing vessel according to item 38, wherein the physical interaction between the opening means of the cartridge's container portion and the opening means of the mixing vessel is effected by connecting the receptacle and the cap of the mixing vessel to each other.
40. The mixing vessel according to item 38 or 39, wherein the receptacle and the cap comprise a liquid-tight closure.
41. The mixing vessel according to any of items 38 to 40, wherein the receptacle and the cap can be connected to each other by a thread.
42. The mixing vessel according to any of items 38 to 41, wherein the receptacle has an inner volume in the range of from 20 ml to about 500 ml or from about 50 ml to about 200 ml.
43. The mixing vessel according to any of items 38 to 42, wherein the receptacle is prefilled with an aqueous liquid for the preparation of the liquid pharmaceutical or nutraceutical formulation, preferably comprising at least two active pharmaceutical ingredients and the at least one excipient.
44. Kit comprising the cartridge according to any of items 1 to 37 and a matching mixing vessel for preparing a liquid pharmaceutical or nutraceutical formulation, preferably comprising the at least two active pharmaceutical ingredients and the at least one excipient, according to any one of items 38 to 43.
45. A method for preparing a liquid pharmaceutical or nutraceutical formulation, preferably comprising at least two active pharmaceutical ingredients and the at least one excipient, the method comprising the steps of:
   a) providing a cartridge according to any one of items 1 to 37;
   b) providing a mixing vessel according to any one of items 38 to 43;
   c) optionally filling the receptacle of the mixing vessel with an aqueous liquid;
   d) connecting the cartridge and the receptacle of the mixing vessel, preferably attaching or inserting the cartridge onto or into the receptacle of the mixing vessel;
   e) connecting the receptacle with the cap of the mixing vessel, and
   f) bringing the cartridge in an opened state, specifically by closing the receptacle by the cap of the mixing vessel.
46. The method according to item 45, further comprising the steps of:
   g) detaching the cap from the receptacle of the mixing vessel; and
   h) removing the cartridge from the receptacle.
47. A liquid pharmaceutical or nutraceutical formulation, preferably comprising at least two active pharmaceutical ingredients and the at least one excipient, obtained or obtainable by a method according to item 45 or 46.
48. Method for the manufacture of a cartridge according any one of items 1 to 37, the method comprising the steps of:
   a₁) providing the container portion of the cartridge according to any one of items 1 to 37;
   b₁) selectively filling the at least three segments of the inner lumen of the container portion with the at least three flowable pharmaceutical or nutraceutical compositions, specifically comprising at least two active pharmaceutical ingredients and at least one excipient; and c₁) closing the filled container portion of the cartridge with the cover portion.
49. The method according to item 48, further comprising the step of:
   a₂) coating the inner surface of the container portion and the surfaces of the segmenting structure (to be exposed to the at least three flowable pharmaceutical or nutraceutical compositions) and/or the inner surface of the cover portion with a non-stick coating.
50. The method according to item 48 or 49, further comprising the step of:
   a₃) sterilizing the container portion (before filling).

1. A cartridge (1) for the preparation of a liquid pharmaceutical or nutraceutical formulation, the cartridge (1) being adapted for insertion into a mixing vessel (100) and for dispensing at least three flowable pharmaceutical or nutraceutical compositions into said mixing vessel (100), the cartridge comprising a container portion (10), a cover portion (20) and an opening means (30) for opening the cartridge (1), wherein
the container portion (10) comprises
a) a container wall (11) and a container base (12), the container wall (11) and the container base (12) defining an inner lumen (13) and an opening (14) of the container portion, the opening (14) being positioned opposite to the container base (12), and
b) a segmenting structure (15) located in the inner lumen (13) of the container portion and being physically connected to the container wall (11) and/or to the container base (12) such as to divide the inner lumen (13) of the container portion into at least three segments (16) containing the at least three flowable pharmaceutical or nutraceutical compositions; and
wherein
the cover portion (20) is attached to the container portion (10) and, in a closed state, contacts the container wall (11) and the segmenting structure (15), thereby closing the at least three segments (16) of the inner lumen of the container portion; and wherein
the opening means (30) is adapted to partially remove the cover portion (20) from the container wall (11) and/or the segmenting structure (15), thereby opening the at least three segments (16) of the inner lumen of the container portion to dispense the flowable pharmaceutical or nutraceutical compositions contained therein into the mixing vessel (100).

2. The cartridge according to claim 1, wherein each of the at least three segments (16) contains one of the at least three flowable pharmaceutical or nutraceutical compositions.

3. The cartridge according to claim 1, wherein each of said at least three flowable pharmaceutical or nutraceutical compositions is different from the other compositions present in the cartridge.

4. The cartridge according to claim 1, wherein the at least three flowable pharmaceutical or nutraceutical compositions combined comprise at least two active pharmaceutical ingredients and at least one excipient.

5. The cartridge according to claim 4, wherein each of the at least two active pharmaceutical ingredients is present in only one of the at least three flowable pharmaceutical or nutraceutical compositions.

6. The cartridge according to claim 1, wherein one of the segments (16) contains a flowable pharmaceutical or nutraceutical composition that does not comprise an active pharmaceutical ingredient, and wherein each of the other segments (16) contain a pharmaceutical or nutraceutical composition comprising an active pharmaceutical ingredient.

7. The cartridge according to claim 1, wherein one or more of the flowable pharmaceutical or nutraceutical compositions are provided in form of a powder, granules, or pellets, or in the form of a liquid.

8. The cartridge according to claim 1, wherein the at least three flowable pharmaceutical or nutraceutical compositions combined comprise at least two active pharmaceutical ingredients; and wherein two or more, optionally all, of the at least two active pharmaceutical ingredients are selected from beta-blockers, angiotensin-converting enzyme (ACE) inhibitors, diuretics, calcium channel blockers, oral antidiabetic drugs, HMG-CoA reductase inhibitors (Statins), angiotensin receptor blockers, proton pump inhibitors, antiplatelet drugs, anticoagulant drugs, alpha-blockers, antidepressants, antiemetics, anticonvulsants, anti-inflammatory drugs, anxiolytic drugs, dopamine receptor agonists, neuroleptics, antidementia drugs, analgesics, mucoactive agents, antiparkinson drugs, sympathomimetic drugs, and xanthine oxidase inhibitors.

9. The cartridge according to claim 1, wherein the at least three flowable pharmaceutical or nutraceutical compositions, preferably the pharmaceutical or nutraceutical composition that does not comprise an active ingredient, comprises at least one excipient selected from thickeners, wetting agents, antifoaming agents, binders and diluents.

10. The cartridge according to claim 1, wherein the segmenting structure (15) is located in the inner lumen (13) of the container portion and is physically connected to the container wall (11) and/or to the container base (12) such as to divide the entire inner lumen (13) of the container portion into at least three segments (16) containing the at least three flowable pharmaceutical or nutraceutical compositions.

11. The cartridge according to claim 1, wherein the container wall (11) comprises an edge (18) surrounding the opening of the container portion and an upper skirt (19) surrounding the opening (14) of the container portion, wherein the upper skirt (19) is radially and outwardly spaced from the edge (18) of the container wall, and wherein the cover portion (20) is connected to, or held in contact with, the upper skirt (19) surrounding the opening (14) of the container portion, and wherein the upper skirt is attached to, or affixed to, the container wall by a hinging connector section (21).

12. The cartridge according to claim 1, wherein the cover portion (20) has an inner surface (25) facing the inner lumen (13) of the container portion and an outer surface (26) facing the outside of the cartridge (1), wherein the cover portion (20) comprises, or is covered by, a detachable sealing foil (27) attached to the outer surface (26) of the cover portion and/or to a circumferential flange (22) of the container portion.

13. The cartridge according to claim 1, wherein the inner surface of the container portion (10) and the surfaces of the segmenting structure (15) are coated with a non-stick coating.

14. A mixing vessel (100) for the preparation of a liquid pharmaceutical or nutraceutical formulation, preferably comprising at least two active pharmaceutical ingredients and at least one excipient, wherein the mixing vessel (100) comprises a receptacle (101) and a cap (102), wherein the receptacle (101) and the cap (102) can be releasably connected with each other, and wherein the receptacle (101) comprises means (103) for receiving the cartridge (1) of claim 1, and wherein the receptacle (101) and/or the cap (102) comprise opening means (104) for bringing the cartridge (1) received in the receptacle (101) to an opened state by physical interaction with the opening means (30) of the cartridge.

15. The mixing vessel according to claim 14, wherein the physical interaction between the opening means (30) of the cartridge, or more specifically the opening means of the container portion thereof, and the opening means (104) of the mixing vessel is effected by connecting the receptacle (101) and the cap (102) of the mixing vessel to each other.

16. A kit comprising the cartridge (1) according to claim 1 and a matching mixing vessel (100) for preparing a liquid pharmaceutical or nutraceutical formulation, preferably comprising the at least two active pharmaceutical ingredients and the at least one excipient wherein the mixing vessel (100) comprises a receptacle (101) and a cap (102), wherein the receptacle (101) and the cap (102) can be releasably connected with each other, and wherein the receptacle (101) comprises means (103) for receiving the cartridge (1), and wherein the receptacle (101) and/or the cap (102) comprise opening means (104) for bringing the cartridge (1) received in the receptacle (101) to an opened state by physical interaction with the opening means (30) of the cartridge.

17. A method for preparing a liquid pharmaceutical or nutraceutical formulation, preferably comprising at least two active pharmaceutical ingredients and the at least one excipient, the method comprising the steps of:
a) providing a cartridge (1) according to claim 1;
b) providing a mixing vessel (100) wherein the mixing vessel (100) comprises a receptacle (101) and a cap (102), wherein the receptacle (101) and the cap (102) can be releasably connected with each other, and wherein the receptacle (101) comprises means (103) for receiving the cartridge (1), and wherein the receptacle (101) and/or the cap (102) comprise opening means (104) for bringing the cartridge (1) received in the receptacle (101) to an opened state by physical interaction with the opening means (30) of the cartridge;
c) optionally filling the receptacle (101) of the mixing vessel with an aqueous liquid;
d) connecting the cartridge (1) and the receptacle (101) of the mixing vessel, preferably attaching or inserting the cartridge (1) onto or into the receptacle (101) of the mixing vessel;
e) connecting the receptacle (101) with the cap (102) of the mixing vessel; and
f) bringing the cartridge (1) in an opened state, specifically by closing the receptacle (101) by the cap (102) of the mixing vessel.

18. A method for the manufacture of a cartridge according to claim 1, the method comprising the steps of:
a₁) providing the container portion (10) of the cartridge (1) according to claim 1;
b₁) selectively filling the at least three segments (16) of the inner lumen (13) of the container portion with the at least three flowable pharmaceutical or nutraceutical compositions, specifically comprising at least two active pharmaceutical ingredients and at least one excipient; and
c₁) closing the filled container portion (10) of the cartridge with the cover portion.
